(19) United States
(12) Patent Application Publication
(10) Pub. No.: US 2026/0356512 A1
(43) Pub. Date: Nov. 12, 2026

(54) ROTORCRAFT WITH ADJUSTABLE WINGSPAN

(71) Applicant: Singapore University of Technology and Design, Singapore (SG)

(72) Inventors: Shaohui FOONG, Singapore (SG); Hitesh BHARDWAJ, Singapore (SG); Xinyu CAI, Singapore (SG)

(73) Assignee: Singapore University of Technology and Design, Singapore (SG)

(21) Appl. No.: 19/481,564

(22) PCT Filed: May 3, 2024
(86) PCT No.: PCT/SG2024/050292

§ 371 Date: Nov. 5, 2025

(30) Foreign Application Priority Data
May 5, 2023 (SG) 10202301258Q

(51) Int. Cl. B64U 30/293; B64U 10/10; B64U 30/12; B64U 30/21; B64U 40/20

(52) U.S. Cl. CPC B64U 30/293; B64U 10/10; B64U 30/12; B64U 30/21; B64U 40/20

(57) ABSTRACT

A rotorcraft with adjustable wingspan is provided, including: a housing member having disposed thereon a flight controller operable to control a flight of the rotorcraft; a wing member coupled to the housing member at a first side thereof, whereby the wing member is configured to produce an aerodynamic force for generating a lift when the rotorcraft is rotating and the wing member is in an extended state; a wingspan control system coupled to the housing member and configured to control a wingspan of the wing member during flight between the extended state and a folded state, whereby the wingspan control system comprises a wing support frame configured to support the wing member; and a thrust unit configured to generate a thrust for rotating the rotorcraft, whereby the flight controller is communicatively coupled to the thrust unit for controlling the thrust unit to control the flight of the rotorcraft.

### CROSS-REFERENCE TO RELATED APPLICATION

This application claims the benefit of priority of Singapore Patent Application No. 10202301258Q, filed on 5 May 2023, the content of which being hereby incorporated by reference in its entirety for all purposes.

### TECHNICAL FIELD

The present invention generally relates to a rotorcraft with adjustable wingspan, and more particularly, that is capable of folding (or retracting) and unfolding (or expanding) its wing(s) during flight.

### BACKGROUND

In recent years, unmanned aerial vehicles (UAVs), in particular quadrotors, have become an integral part of many industries. Quadrotors have proven to be incredibly useful for various applications such as delivering packages, inspecting building structures, surveillance, etc. Their maneuverability is a significant advantage as it allows them to safely and efficiently access hard-to-reach or dangerous locations, providing an alternative to human labor. However, due to the aerodynamic lift being generated directly by the propellers, quadcopters are not the most power-efficient vehicles. This is because according to the momentum theory, the hovering power is inversely proportional to the rotor radius. In contrast to these traditional multi-rotors, fixed-wing aerial robots show much higher power efficiency by making advantage of their huge airfoils, but conventionally, these are not suitable for operations in confined spaces due to their forward velocity, as well as they lack the ability to hover and vertical take-off and landing. Similar to the fixed wings, rotating aerial vehicles have also shown high flight efficiency.

Monocopters are a class of samara-inspired rotorcrafts, which, unlike quadrotors, rely on the aerodynamic lift being generated by their entire wing. They fly by constantly rotating about their yaw axis, using a single wing to generate the lift required for hovering. Recent research has proven that this configuration is far more efficient compared to the quadrotors. For example, samara seeds are known for their ability to auto-rotate while falling to slow their descent rate and disperse. Monocopters carry the inherent advantage of autorotation from samara seeds, which helps them to descend gracefully in case of a power failure. The concept of monocopters is not new and has been researched in different studies. Although the first implementation of this theory dates to the 1900s, the recent developments began with a publication by MIT in 2008, namely, Houghton et al., “Flying-by-wire control of a monocopter”, MIT, Project Report, 2008.

Some of the applications of monocopters include unpowered lightweight sensor, short-range urban surveillance, LiDAR inertial odometry, and passively scanning and mapping the surrounding environment using Simultaneous Localization and Mapping (SLAM). Monocopters usually have two actuators to achieve flight and control: a motor and a servo to control the flap. The concept of single actuator monocopter was first introduced in Win et al., “Achieving Efficient Control Flight with A Single Actuator”, 2020 IEEE/ASME International Conference on Advanced Intelligent Mechatronics (AIM), 2020, pp. 1625-1631 (herein referred to as the Win 2020 reference), where the authors utilized a single motor for directional as well as altitude control of the monocopter. On the other hand, a recent study demonstrated the use of monocopters in a two-flight mode capable rotorcraft, where the second flight mode is obtained by implementing extra actuators for the second flight mode. The monocopters concept has been extended to dual wings for the development of Transformable Hovering Rotorcraft in Low, et al., “Design and dynamic analysis of a Transformable Hovering Rotorcraft (THOR)”, where the authors have utilized four actuators to control the altitude and direction of the UAV. The dual-wing configuration was also used as a cooperative configuration in Cai et al., “Cooperative Modular Singular Actuator Monocopters Capable of Controlled Passive Separation”, International Conference on Robotics and Automation (ICRA), 2022, pp. 1989-1995, where the authors presented the capability of the platform to fly in a dual-wing configuration and passively separate during flight. There has also been disclosed a modular version of the monocopter platform, whereby the adaptability and control of the platform using different configurations was demonstrated.

Traditionally, the monocopters have been developed using lightweight materials such as carbon fiber, foam, balsa wood or a combination of balsa wood and foam. This ensures that the wing remains light as well as rigid, to provide lift when flying at a certain angle with respect to the oncoming airflow. The first attempt to use a flexible, semi-rigid wing for a monocopter was done in Win et al., “Design and Control of the First Foldable Single-Actuator Rotary Wing Micro Aerial Vehicle”, Bioinspiration & Biomimetics, vol. 16, no. 6, 2021, where the authors introduced a foldable single actuator monocopter that can be folded up into a compact pocketable form for storage when not in flight. However, the concept of foldable wing(s) for rotorcrafts during flight does not appear to have been researched. For rotorcrafts, being able to fold and unfold wing(s) during flight is advantageous as it enhances the adaptability of the rotorcraft during flight and the usability/applicability of the rotorcraft for a wider range of practical applications.

A need therefore exists to provide a rotorcraft (which may also be referred to as a rotating aerial vehicle or robot) with adjustable wingspan that seeks to overcome, or at least ameliorate, one or more deficiencies in conventional rotorcrafts without adjustable wingspan, and more particularly, that enhances the adaptability of the rotorcraft during flight and the usability/applicability of the rotorcraft for a wider range of practical applications. It is against this background that the present invention has been developed.

### SUMMARY

According to a first aspect of the present invention, there is provided a rotorcraft with adjustable wingspan, comprising:
a housing member having disposed thereon a flight controller operable to control a flight of the rotorcraft;
a wing member coupled to the housing member at a first side thereof, wherein the wing member is configured to produce an aerodynamic force for generating a lift when the rotorcraft is rotating and the wing member is in an extended state;
a wingspan control system coupled to the housing member and configured to control a wingspan of the wing member during flight between the extended state and a folded state, wherein the wingspan control system comprises a wing support frame configured to support the wing member; and
a thrust unit configured to generate a thrust for rotating the rotorcraft, wherein the flight controller is communicatively coupled to the thrust unit for controlling the thrust unit to control the flight of the rotorcraft.

According to a second aspect of the present invention, there is provided a method of forming the rotorcraft according to the above-mentioned first aspect of the present invention.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic drawing of a rotorcraft with adjustable wingspan, according to various embodiments of the present invention;

FIG. 2 depicts a schematic flow diagram of a method of forming the rotorcraft with adjustable wingspan, according to various embodiments the present invention;

FIG. 3A shows a bird having the ability to fold its wings and pass through gaps smaller than their wingspan;

FIG. 3B shows a Peregrine falcon starting to dive;

FIG. 4 shows images of a first example rotorcraft with adjustable wingspan, which may herein be referred to as a FROW-P (foldable rotary origami wing-passive) rotorcraft, according to various example embodiments of the present invention;

FIG. 5 show images of a second example rotorcraft with adjustable wingspan, which may herein be referred to as a FROW-A (foldable rotary origami wing-active) rotorcraft, according to various example embodiments of the present invention;

FIG. 6 depicts a schematic drawing illustrating the unwinded (corresponding to the expanded state) and winded (corresponding to the folded state) spring model for the FROW-P rotorcraft, according to various example embodiments of the present invention;

FIG. 7A shows a plot of experimental data showing the displacement of the string of the wingspan control system of the first example rotorcraft subjected to different loads, according to various example embodiments of the present invention;

FIG. 7B shows a plot illustrating the approximation of the centrifugal force F_{c} generated by the first example rotorcraft as the rotational speed Ω_{z} changes based on a centrifugal force formula along with the relationship between the rotational speed Ω_{z} and the string displacement Δx obtained theoretically, according to various example embodiments of the present invention;

FIG. 7C shows the first example rotorcraft (FROW-P rotorcraft) rotorcraft rotating at various rotational speeds during the flight, according to various example embodiments of the present invention;

FIG. 8 shows a table (Table 1) comparing various example dimensions of the expanded and folded configurations for the first and second example rotorcrafts (FROW-P and FROW-A rotorcrafts), according to various example embodiments of the present invention;

FIG. 9 shows images of the second example rotorcraft (FROW-A rotorcraft) in flight in the extended state (top image) and the folded state (bottom image), according to various example embodiments of the present invention;

FIG. 10A depicts a schematic drawing of the second example rotorcraft (FROW-A rotorcraft), along with the inertial reference frame (X, Y, Z), the body reference frame (x, y, z) and the direction of rotation Ω_{z}, according to various example embodiments of the present invention;

FIG. 10B depicts a schematic drawing of an example single blade element of the rotorcraft, along with representation of aerodynamic forces on the single blade element, according to various example embodiments of the present invention;

FIGS. 11A and 11B depict plots of experimental results showing the effect of attitude control on the flight of the second example rotorcraft (FROW-A rotorcraft) without attitude stabilization (FIG. 11A) and with attitude stabilization (FIG. 11B), according to various 10 example embodiments of the present invention;

FIG. 12 depicts a plot of the experimental results showing the position of the FROW-A rotorcraft, with (ps) and without (p) the attitude controller, according to various example embodiments of the present invention;

FIGS. 13A and 13B depict plots of the closed-loop waypoint results for the FROW-A rotorcraft obtained for the extended and folded configurations, according to various example embodiments of the present invention;

FIGS. 13C and 13D depict plots of the trajectory tracking results for the FROW-A rotorcraft obtained for the extended and folded configurations, according to various example embodiments of the present invention;

FIGS. 14A and 14B show plots of experimental results showing the position (FIG. 14A) and the attitude (FIG. 14B) of the FROW-A rotorcraft passing through a narrow window, according to various example embodiments of the present invention;

FIG. 14C shows a 3D plot of the trajectory followed by the FROW-A rotorcraft during the experiment;

FIGS. 14D and 14E show selected frames extracted from a video depicting the FROW-A rotorcraft passing through the narrow window during the experiment from a top view (FIG. 14D) and a side view (FIG. 14E);

FIG. 15 shows a plot of the experimental results showing the position control along with the angular velocity and displacement Δx of the wingspan of the FROW-A rotorcraft, according to various example embodiments of the present invention;

FIG. 16A shows a plot of experimental results for the angular velocity of the FROW-P rotorcraft during take-off and hovering, according to various example embodiments of the present invention;

FIG. 16B shows a plot of experimental results (barometer data) for the dive and recovery of the FROW-P rotorcraft hand thrown from 30 m altitude in an outdoor experiment, according to various example embodiments of the present invention;

FIGS. 17A to 17D depict the experimental results obtained from the FROW-P rotorcraft dive and recovery experiment performed from a height of 30 m, according to various example embodiments of the present invention;

FIG. 17E shows overlaying frames from a video showing the FROW-P rotorcraft dive and recovery experiment performed, according to various example embodiments of the present invention; and

FIG. 18 shows a plot of the change of altitude and wingspan of the FROW-P rotorcraft over time for the FROW-P rotorcraft dive and recovery experiment shown in FIGS. 17A and 17E, according to various example embodiments of the present invention.

### DETAILED DESCRIPTION

Various embodiments of the present invention provide a rotorcraft with adjustable wingspan, and more particularly, that is capable of folding (or retracting) and unfolding (or expanding) its wing(s) during flight.

As discussed in the background, for rotorcrafts, being able to fold and unfold wing(s) during flight is advantageous as it enhances the adaptability of the rotorcraft during flight and the usability/applicability of the rotorcraft for a wider range of practical applications. In this regard, various embodiments provide a rotorcraft (which may also be referred to as a rotating aerial vehicle or robot) with adjustable wingspan that seeks to overcome, or at least ameliorate, one or more deficiencies in conventional rotorcrafts without adjustable wingspan, and more particularly, that enhances the adaptability of the rotorcraft during flight and the usability/applicability of the rotorcraft for a wider range of practical applications.

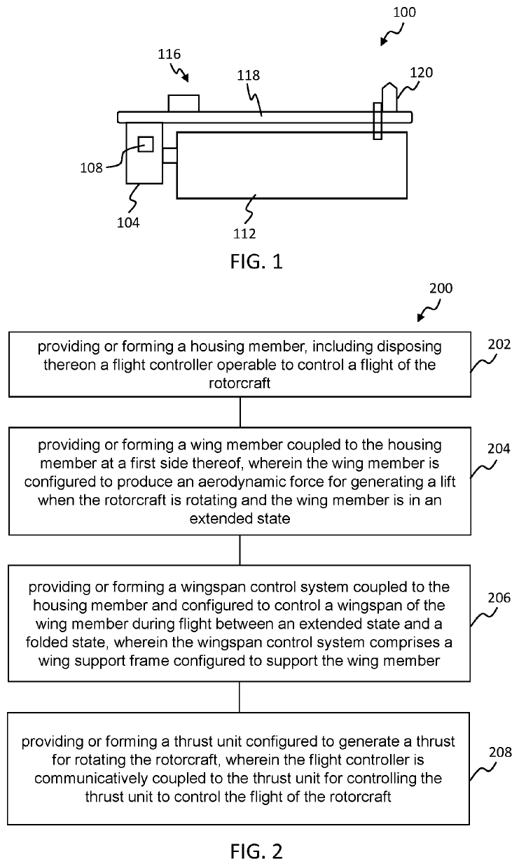

FIG. 1 depicts a schematic drawing of a rotorcraft 100 with adjustable wingspan according to various embodiments of the present invention. The rotorcraft 100 comprises: a housing member 104 having disposed thereon (thereby housing) a flight controller 108 operable to control a flight of the rotorcraft 100; a wing member 112 coupled to the housing member 104 at a first side thereof, wherein the wing member 112 is configured to produce an aerodynamic force for generating a lift when the rotorcraft 100 is rotating and the wing member 112 is in an extended state (which may also be referred to as an expanded state); a wingspan control system 116 coupled to the housing member 104 and configured to control a wingspan of the wing member 112 during flight between the extended state (illustrated in FIG. 1) and a folded state (not illustrated in FIG. 1), wherein the wingspan control system 116 comprises a wing support frame 118 configured to support the wing member 112; and a thrust unit 120 configured to generate a thrust for rotating the rotorcraft 100, wherein the flight controller 108 is communicatively coupled to the thrust unit 120 for controlling the thrust unit 120 to control the flight of the rotorcraft 100.

In various embodiments, the rotorcraft 100 is configured to operate as a rotating rotorcraft whereby the flight of the rotorcraft 100 (e.g., lift thereof) is primarily achieved by rotating/spinning the entire rotorcraft 100 (along with its wing(s)) about its yaw axis from the thrust generated by the thrust unit(s) (e.g., motor-driven propeller(s)).

Accordingly, the rotorcraft 100 according to various embodiments of the present invention is advantageously configured with adjustable wingspan, and more particularly, is capable of folding (or retracting) and unfolding (or expanding) its wing(s) during flight for enhancing the adaptability of the rotorcraft 100 during flight and the usability/applicability of the rotorcraft 100 for a wider range of practical applications. These advantages or technical effects, and/or other advantages or technical effects, will become more apparent to a person skilled in the art as the rotorcraft 100 is described in more detail according to various embodiments and example embodiments of the present invention.

In various embodiments, the wing member 112 comprises a plurality of wing panels arranged in series (successively in a direction in which the wing member 112 extends/expands) and a plurality of foldable portions, each foldable portion being located between a corresponding pair of immediately adjacent wing panels. In other words, each pair of immediately adjacent wing panels is spaced apart by a corresponding foldable portion therebetween. Accordingly, each foldable portion is configured to be able to fold thereat (or foldable thereat) when the wing member 112 is being folded by the wingspan control system 116. Similarly, each foldable portion is configured to be able to unfold thereat (or unfoldable thereat) when the wing member 112 is being unfolded by the wingspan control system 116.

In various embodiments, the wing member 112 is laminated with a film (e.g., plastic film). In this regard, each portion of the film located between a corresponding pair of immediately adjacent wing panels forms the corresponding foldable portion located between the corresponding pair of immediately adjacent wing panels.

In various embodiments, the wing support frame 118 is coupled to the wing member 112 at multiple foldable portions of the plurality of foldable portions and at a last wing panel of the plurality of wing panels for supporting the wing member 112 and facilitating transitions of the wing member 112 between the extended state and the folded state. In various embodiments, the above-mentioned multiple foldable portions may be alternate foldable portions of the plurality of foldable portions. In various embodiments, the wing support frame 118 may be coupled to the above-mentioned multiple foldable portions via multiple hanger supports, respectively.

In various embodiments, the wing support frame 118 is arranged alongside a leading edge of the wing member 112 and is configured to function as a guide rail for the plurality of wing panels. Accordingly, the wing support frame 118 may be coupled to the above-mentioned multiple foldable portions and the above-mentioned last wing panel along the leading edge portion of the wing member 112. In various embodiments, the thrust unit 120 is coupled to the wing support frame 118 at a distal end portion thereof (e.g., distal end portion with respect to the housing member 104).

In various embodiments, the wingspan control system 116 is configured to fold the wing member 112 in an accordion manner. For example, as described above, the wing member 112 is configured to include the plurality of wing panels arranged in series and the plurality of foldable portions, whereby each pair of immediately adjacent wing panels is spaced apart by a corresponding foldable portion. Furthermore, in various embodiments, the wing support frame 118 of the wingspan control system 116 is coupled to multiple (e.g., alternate) foldable portions along the leading edge portion of the wing member 112. In this manner, as the wing support frame 118 retracts, the wing support frame 118 is able to fold the wing member 112 in an accordion manner. Similarly, as the wing support frame 118 extends, the wing support frame 118 is able to unfold the wing member 112 in an accordion manner.

In various embodiments, in the case whereby the wingspan control system 116 is configured to passively or automatically control the wingspan of the wing member 112 during flight, the wingspan control system 116 further comprises a spring device and a string having a first end coupled to the spring device and a second end coupled to the wing member 112 (e.g., at a distal end portion thereof with respect to the spring device or the housing member 104) for controlling the wingspan of the wing member 112. In this regard, the spring device is configured to: when in the folded state, hold the wing member 112 in the folded state via the string with a pre-loaded spring force pulling on the wing member 112 (e.g., at the distal end portion of the wing member 112 towards the spring device or the housing member 104); and release the wing member 112 towards the extended state when the rotorcraft 100 is controlled by the flight controller 108 to rotate at a rotational speed which generates a centrifugal force which exceeds a spring force pulling on the wing member 112 produced by the spring device via the string, thereby increasing the wingspan of the wing member 112 and storing elastic potential energy in the spring device. In other words, the spring device is configured to release the wing member 112 towards the extended state when the centrifugal force generated by the rotating rotorcraft 100 overcomes the spring force pulling on the wing member 112.

In various embodiments, the spring device is configured to retract the wing member 112 towards the folded state when the rotorcraft 100 is controlled by the flight controller 108 to rotate at a rotational speed which generates a centrifugal force which is less than the spring force pulling on the wing member 112 produced by the spring device via the string, thereby reducing the wingspan of the wing member 112. In other words, the spring device is configured to retract the wing member 112 towards the folded state when the centrifugal force generated by the rotating rotorcraft is less than (or not sufficient to overcome) the spring force pulling on the wing member 112. In various embodiments, the folded state is a fully folded state and the extended state is a fully extended state.

In various embodiments, the wing support frame 118 is a telescopic rod and the spring device is a spiral spring device.

Accordingly, in various embodiments, the rotorcraft 100 is a monocopter.

In various embodiments, in the case whereby the wingspan control system 116 is configured to actively control the wingspan of the wing member 112 during flight, the wingspan control system 116 further comprises a servo motor and a string having a first end coupled to the servo motor (e.g., via a spool) and a second end coupled to the wing member (e.g., at a distal end portion thereof with respect to the spring device or the housing member 104) for controlling the wingspan of the wing member 112. In this regard, the servo motor is configured to: retract, based on the servo motor receiving a wingspan control input to retract, the wing member 112 towards the folded state by reeling in (e.g., via a spool) the string (e.g., thereby pulling on the wing member 112 at the distal end portion thereof), thereby reducing the wingspan of the wing member 112; and release, based on the servo motor receiving a wingspan control input to release, the wing member 112 towards the extended state by releasing the string for allowing the wing member 112 to extend towards the extended state via a centrifugal force produced when the rotorcraft 100 is being rotated, thereby increasing the wingspan of the wing member 112. In other words, to expand the wing member 112 towards the extended state, the string may be loosened so as to allow/enable the centrifugal force produced by the rotating rotorcraft 100 to extend the wing member 112 towards the extended state. In various embodiments, the folded state is a fully folded state and the extended state is a fully extended state.

In various embodiments, the above-mentioned wing member 112 is (or corresponds to) a first wing member, the above-mentioned wingspan control system 116 is (or corresponds to) a first wingspan control system, and the above-mentioned thrust unit 120 is (or corresponds to) a first thrust unit. In this regard, in various embodiments, the rotorcraft 100 further comprises: a second wing member coupled to the housing member 104 at a second side thereof, wherein the second wing member is configured to produce an aerodynamic force for generating a lift when the rotorcraft 100 is rotating and the second wing member is in an extended state; a second wingspan control system coupled to the housing member 104 and configured to control a wingspan of the second wing member during flight between the extended state and a folded state, wherein the second wingspan control system comprises a second wing support frame configured to support the second wing member; and a second thrust unit configured to generate a thrust for rotating the rotorcraft 100, wherein the flight controller 108 is communicatively coupled to the second thrust unit for controlling the second thrust unit (together with the first thrust unit 120) to control the flight of the rotorcraft 100. Accordingly, the second wing member, the second wingspan control system and the second thrust unit may be configured in the same or corresponding manner as the first wing member 112, the first wingspan control system 116 and the first thrust unit 120, respectively, but are arranged with respect to (to extend from) the second side of the housing member 104 instead of the first side of the housing member 104. In various embodiments, the first and second sides of the housing member 104 are opposite sides thereof.

Accordingly, in various embodiments and in the same or corresponding manner as the first wing member 112, the second wing member comprises a plurality of wing panels arranged in series and a plurality of foldable portions, each foldable portion being located between a corresponding pair of immediately adjacent wing panels.

Accordingly, in various embodiments and in the same or corresponding manner as the first wing member 112, the second wing member is laminated with a film (e.g., a plastic film). In this regard, each portion of the film located between a corresponding pair of immediately adjacent wing panels forms the corresponding foldable portion located between the corresponding pair of immediately adjacent wing panels.

Accordingly, in various embodiments and in the same or corresponding manner as the first wing support frame 118, the second wing support frame is coupled to the second wing member at multiple foldable portions of the plurality of foldable portions and at a last wing panel of the plurality of wing panels for supporting the second wing member and facilitating transitions of the second wing member between the extended state and the folded state.

Accordingly, in various embodiments and in the same or corresponding manner as the first wing support frame 118, the second wing support frame is arranged alongside a leading edge of the second wing member and is configured to function as a guide rail for the plurality of wing panels. Similarly, the second thrust unit is coupled to the second wing support frame at a distal end portion thereof.

Accordingly, in various embodiments and in the same or corresponding manner as the first wingspan control system 116, the second wingspan control system is configured to fold the second wing member in an accordion manner.

Accordingly, in various embodiments and in the same or corresponding manner as the first wingspan control system 116 configured to actively control the wingspan of the first wing member 112 during flight, the second wingspan control system further comprises a servo motor (or a second servo motor) and a string (or a second string) having a first end coupled to the servo motor and a second end coupled to the second wing member for controlling the wingspan of the second wing member. In this regard, the servo motor is configured to: retract, based on the servo motor receiving a wingspan control input to retract, the second wing member towards the folded state by reeling in the string, thereby reducing the wingspan of the second wing member; and release, based on the servo motor receiving a wingspan control input to release, the second wing member towards the extended state by releasing the string for allowing the second wing member to extend towards the extended state via a centrifugal force produced when the rotorcraft is being rotated, thereby increasing the wingspan of the second wing member.

In various embodiments, the first and second thrust units may each comprise a propeller and a motor configured to rotate the propeller. It will be appreciated by a person skilled in the art that the present invention is not limited to any particular type of thrust unit for the first and second thrust units as long as the thrust unit is capable of being operated to generate thrust to facilitate or support a flight of the rotorcraft 100 as described herein according to various embodiments. It will be appreciated by a person skilled in the art that the first and second wing members may be configured to have any shape as desired or as appropriate, as long as the rotorcraft 100 can operate as a rotating rotorcraft. Accordingly, the first and second wing members are not limited to any particular wing shape. For example, it will be appreciated by a person skilled in the art that the wing shape may be determined or configured via an optimization process for enhancing flight performance.

In various embodiments, the flight controller 108 may be software module(s) realized by computer program(s) or set(s) of instructions executable by a computer processor to perform various functions or operations. In various embodiments, the flight controller 108 may be implemented as hardware module(s) being functional hardware unit(s) designed to perform various functions or operations. For example, a hardware module may be implemented using discrete electronic components, or it may form a portion of an entire electronic circuit such as an Application Specific Integrated Circuit (ASIC). Numerous other possibilities exist. It will also be appreciated by a person skilled in the art that a combination of hardware and software modules may be implemented.

FIG. 2 depicts a schematic flow diagram of a method 200 of forming the rotorcraft 100 with adjustable wingspan according to various embodiments the present invention. The method 200 comprises: providing or forming (at 202) a housing member 104, including disposing thereon a flight controller 108 operable to control a flight of the rotorcraft 100; providing or forming (at 204) a wing member 112 coupled to the housing member 104 at a first side thereof, wherein the wing member 112 is configured to produce an aerodynamic force for generating a lift when the rotorcraft 100 is rotating and the wing member 112 is in an extended state; providing or forming (at 206) a wingspan control system 116 coupled to the housing member 104 and configured to control a wingspan of the wing member 112 during flight between the extended state and a folded state, wherein the wingspan control system 116 comprises a wing support frame 118 configured to support the wing member 112; and providing or forming (at 208) a thrust unit 120 configured to generate a thrust for rotating the rotorcraft 100, wherein the flight controller 108 is communicatively coupled to the thrust unit 120 for controlling the thrust unit 120 to control the flight of the rotorcraft 100.

The method 200 is for forming the rotorcraft 100 as described hereinbefore with reference to FIG. 1, therefore, various steps or operations of the method 200 correspond to forming, providing or configuring various components, modules or portions of the rotorcraft 100 as described herein according to various embodiments, and thus such corresponding steps or operations need not be described or repeated with respect to the method 200 for clarity and conciseness. In other words, various embodiments described herein in context of the rotorcraft 100 are analogously valid for the method 200 of forming the rotorcraft 100 having various components, modules, portions and configurations as described hereinbefore according to various embodiments, and vice versa. FIG. 2 does not limit any particular order of operations/steps in which the method 200 can be performed to form the rotorcraft 100. Furthermore, one or more operations/steps of the method 200 may be performed concurrently or integrally as desired or as appropriate without going beyond the scope of the present invention. For example, various components or parts of the rotorcraft 100 may be 3D printed components or parts, such as but not limited to, the housing member 104, the first and second wing members, along with various other components or parts of the rotorcraft 100, to form the rotorcraft 100 as described herein according to various embodiments of the present invention.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Any reference to an element or a feature herein using a designation such as “first”, “second” and so forth does not limit the quantity or order of such elements or features, unless stated or the context requires otherwise. For example, such designations may be used herein as a convenient way of distinguishing between two or more elements or instances of an element. Thus, a reference to first and second elements does not necessarily mean that only two elements can be employed, or that the first element must precede the second element, unless stated or the context requires otherwise. In addition, a phrase referring to “at least one of” a list of items refers to any single item therein or any combination of two or more items therein.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

As discussed in the background, for rotorcrafts, being able to fold and unfold wing(s) during flight is advantageous as it enhances the adaptability of the rotorcraft during flight and the usability/applicability of the rotorcraft for a wider range of practical applications. Accordingly, in various example embodiments, a rotorcraft provided with adjustable wingspan that seeks to overcome, or at least ameliorate, one or more deficiencies in conventional rotorcrafts without adjustable wingspan, and more particularly, that enhances the adaptability of the rotorcraft during flight and the usability/applicability of the rotorcraft for a wider range of practical applications. In various example embodiments, through active or passive control, the wingspan of the rotorcraft is controlled during its flight.

Various aerial vehicles capable of actively changing shape have been previously developed. For example, self-foldability and self-deployability were explored in Tuna et al., “FOLLY: A Self Foldable and Self Deployable Autonomous Quadcopter”, 2018 6^{th} International Conference on Control Engineering & Information Technology (CEIT), pp. 1-6, 2018. Active morphology of the shape of the robot helped achieve multi-modal flying and walking ability in Daler et al., “A bioinspired multi-modal flying and walking robot”, Bioinspiration & biomimetics, 10(1), 016005, 2015, whereas, in Falanga et al., “The foldable drone: A morphing quadrotor that can squeeze and fly”, IEEE Robotics and Automation Letters, vol. 4, no. 2, pp. 209-216, April 2019, active morphology contributed to negotiation through narrow gaps, close inspection of surfaces, and object grasping. In Enrico et al., “Bioinspired wing and tail morphing extends drone flight capabilities”, Science Robotics 5.47 (2020): eabc2897, active control over the folding of wings helps improve the robot's maneuverability, agility, and stability. Several designs have also been proposed that enable aerial vehicles to passively change the shape of their body. For example, Bouman et al., “Design and autonomous stabilization of a ballistically-launched multirotor”, 2020 IEEE International Conference on Robotics and Automation (ICRA), pp. 8511-8517, 2020 and Mintchev et al., “Foldable and self-deployable pocket sized quadrotor”, 2015 IEEE International Conference on Robotics and Automation (ICRA), pp. 2190-2195, 2015 demonstrated the automatic unfolding of an aerial vehicle after launch, while Dufour et al., “A drone with insect-inspired folding wings”, 2016 IEEE/RSJ International Conference on Intelligent Robots and Systems (IROS), 2016, pp. 1576-1581, presented a manually foldable wing drone with rapid deployment capabilities. Although these aerial vehicles could be ideal for compact storage and rapid deployment, they do not focus on repeatedly changing the shape after deployment and therefore require manual assistance to be returned to their compressed forms.

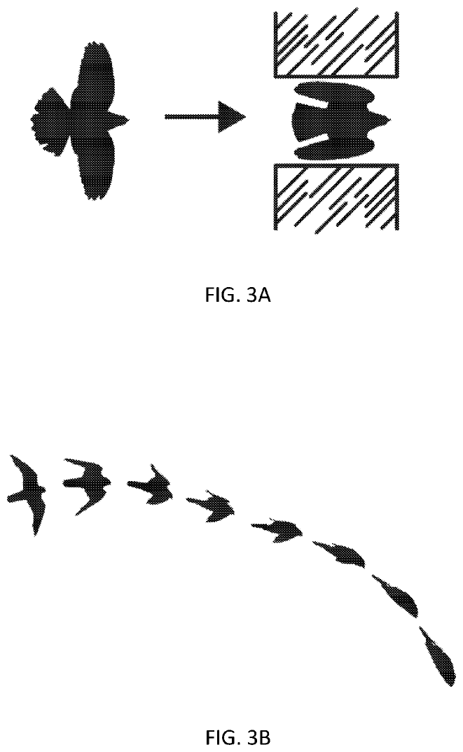

Various example embodiments present the design and development of a rotorcraft with adjustable wingspan, which may herein be referred to as a Foldable Rotary Origami Wing (FROW) rotorcraft (e.g., corresponding to the rotorcraft 100 with adjustable wingspan as described hereinbefore according to various embodiments of the present invention). For example, one of the drawbacks of conventional monocopters during their flight is their large footprint which hinders their ability to maneuver through tight spaces. However, for example as illustrated in FIG. 3A, birds have the ability to fold their wings and pass/navigate through gaps smaller than their wingspan. Accordingly, various example embodiments seek to provide the FROW rotorcraft with the ability to fold its wing(s) during flight to reduce its footprint, making such an aerial platform more flexible in its usability. Various example embodiments introduce two different configurations of this aerial platform which have similarities in their principle and design concept, however, they differ in their manner of controlling the wingspan and practical applications. In particular, a rotorcraft (herein referred to as FROW-A rotorcraft (i.e., FROW-Active)) with an active wingspan control system is provided for actively controlling its wing folding using actuators and a rotorcraft (herein referred to as FROW-P rotorcraft (i.e., FROW-Passive) with a passive wingspan control system is provided for passively (or automatically) controlling its wing folding and requires no actuators.

In various example embodiments, the FROW-A rotorcraft is designed to actively control (e.g., via control input by a user or operator) its wingspan in flight, thereby allowing for alterations or adaptability in its footprint in flight. For example, this feature enables the extended wing configuration (i.e., extended state) of the FROW-A rotorcraft to be utilized for its power-efficient flight, while the folded wing configuration (i.e., folded state) facilitates maneuvering through narrow spaces and obstacles when required. Reducing the footprint in flight can also help in obtaining a stealthy approach to avoid radar detection as well as aggressive maneuvers. In addition, modifying the wingspan also affects the rotational speed of the rotorcraft. In this regard, according to various example embodiments, active control of rotational speed may be performed to eliminate the need for a camera or Lidar sensor tuning and allow direct synchronization with optimal rates as required while airborne.

In comparison to the foldable monocopter developed by the above-mentioned Win 2020 reference, the FROW-P rotorcraft boasts a unique feature where it eliminates the need for manual assistance for both folding and unfolding its wing, thereby advantageously providing a passive or automatic wingspan control system. For example, the configuration permits the wing to automatically extend during takeoff and retract with ease when approaching landing. For example, birds may fold up their wings behind their body to quickly plunge through the air. Cape Gannet uses this ability to take nose dives toward the water to dive deeper, whereas Peregrine Falcon uses the same principle to simply hurtle thousands of feet through the air at high speeds to quickly descend towards its prey, such as illustrated in FIG. 3B. In this regard, the FROW-P rotorcraft is designed to also enable a diving action. A previous work done by Win et al., “An Agile Samara-Inspired Single-Actuator Aerial Robot Capable of Autorotation and Diving”, in IEEE Transactions on Robotics, vol. 38, no. 2, pp. 1033-146 April 2022, achieved the diving of a monocopter by utilizing its flap. By deflecting the flap to a large angle of attack, the authors managed to deflect the airflow to enter a dive mode. However, the FROW-P rotorcraft does not require an additional actuator to enable the monocopter to dive. In particular, with the help of its passive wingspan control system (or passive wing folding mechanism), the FROW-P rotorcraft can plunge through the air to dive and quickly descend. For example, this type of maneuver may be employed for bypassing harsh weather conditions when flying at high altitudes. The maneuver can also be employed for a more acrobatic and agile monocopter depending on the type of application. Changing various folding mechanism parameters allows the FROW-P rotorcraft to be flown with different wing spans. For example, as will be described later below according to various example embodiments of the present invention, the passive wingspan control system of the FROW-P rotorcraft may employ a spiral spring for folding and unfolding the wing. In this regard, by changing/modifying various parameters of this spiral spring (such as diameter, pre-loaded spring force, etc.), different wingspans (e.g., different lengths of wingspan at the fully extended state) can be achieved. Additionally, such parameters may be changed/modified to adjust the rotational speed profile of the FROW-P rotorcraft. For example, since the wingspan of the rotorcraft is proportional to the rotational speed, by tuning such parameters to adjust the wingspan, a desired rotational speed profile (e.g., achieve a certain desired rotational speed when the wing is fully extended) in flight can be achieved. For example, this relationship is reflected in Equation (4b) to be described later below according to various example embodiments of the present invention.

Accordingly, rotorcrafts with adjustable wingspan (FROW rotorcrafts) according to various example embodiments advantageously have improved versatility in this technical field, such as improved adaptability during flight and usability for a wider range of practical applications. In this regard, various example embodiments advantageously provide the following:
the design and development of two example configurations of rotorcrafts with adjustment wingspan, namely, the above-mentioned FROW-A and FROW-P rotorcrafts, are presented, which can fold their wing(s) based on active and passive control mechanisms, respectively, during flight. In the folded state, the FROW-A and FROW-P rotorcrafts can reduce the overall length of their wingspan by, for example, 39.18% and 65.19%, respectively, while still in the air.
Experimental verification is performed to observe the FROW rotorcraft's performance during the folding and unfolding of wing(s) during flight. For example, experimental results for position hold during closed-loop waypoint and trajectory tracking experiments are presented. Experimental results for extended/expanded and folded modes/states while holding the position are also presented, verifying the practical use by reducing the footprint and maneuvering through small gaps.
Experimental proof for the passive wingspan control system (or passively foldable mechanism) is presented, whereby successful flights using the platform featuring its diving and recovery capability in flight are demonstrated.

Example rotorcrafts with adjustable wingspan (example FROW rotorcrafts or prototypes) will now be described in further detail according to various example embodiments of the present invention, including design principles, as well as various different parts and components onboard example FROW prototypes. Dynamic modeling and flight control of the example rotorcrafts with adjustable wingspan will also be described according to various example embodiments of the present invention.

### Example Rotorcraft Configurations (Example Prototype Designs)

Example configurations of two example rotorcrafts with adjustable wingspan, as well as corresponding two example prototype designs (FROW-P and FROW-A), will now be described according to various example embodiments of the present invention, including design and manufacturing of the wing(s) and onboard electronic components. For each of the two example rotorcrafts, its wing contraction and expansion mechanism, its modeling and verification of the modelling using experimental techniques will also be described according to various example embodiments of the present invention.

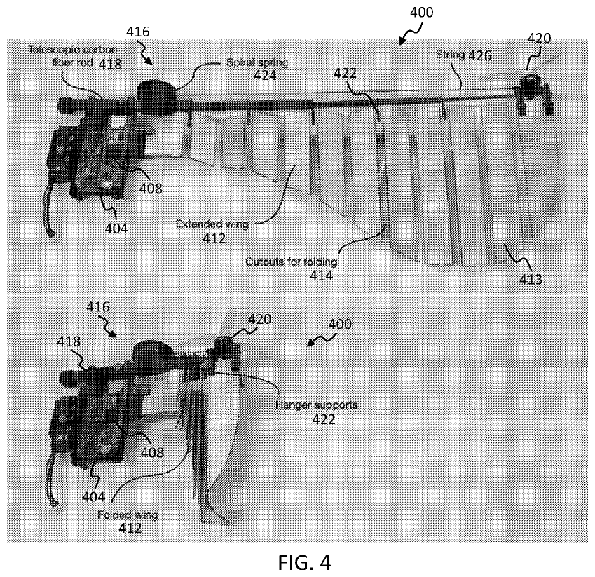

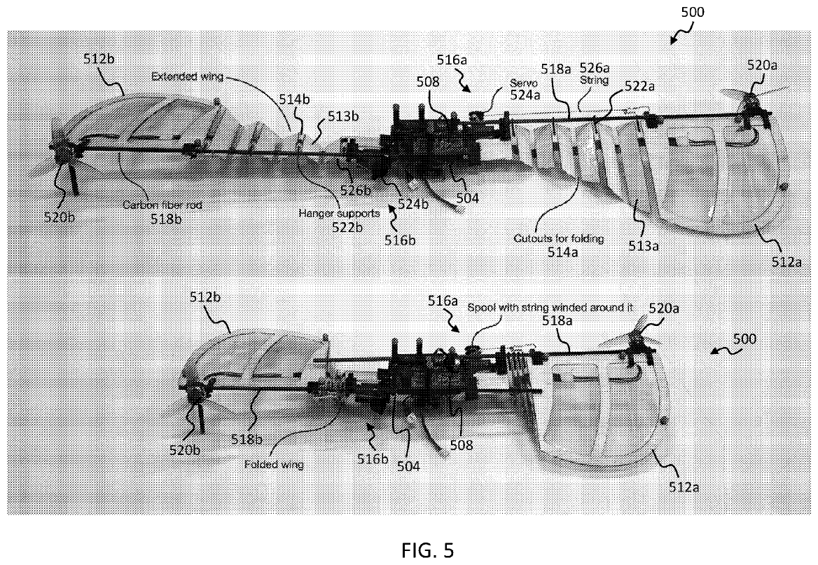

FIG. 4 show images of a first example rotorcraft 400 with adjustable wingspan corresponding to the FROW-P rotorcraft, according to various example embodiments of the present invention, including illustrations of the wing 412 being in an extended state (fully extended) (which may also be referred as an expanded state) (top image) and a folded state (fully folded) (bottom image). FIG. 5 show images of a second example rotorcraft 500 with adjustable wingspan corresponding to the FROW-A rotorcraft, according to various example embodiments of the present invention, including illustrations of the wings 512a, 512b being in the extended state (fully extended) (top image) and the folded state (fully folded) (bottom image).

As shown in FIGS. 4 and 5, the first and second example rotorcrafts 400, 500 each comprises: a housing member 404, 504 having disposed thereon (thereby housing) a flight controller 408, 508 operable to control a flight of the rotorcraft 400, 500; a wing member 412, 512a coupled to the housing member 404, 504 at a first side thereof, wherein the wing member 412, 512a is configured to produce an aerodynamic force for generating a lift when the rotorcraft 400, 500 is rotating and the wing member 412, 512a is in the extended state; a wingspan control system 416, 516a coupled to the housing member 404, 504 and configured to control a wingspan of the wing member 412, 512a during flight between the extended state and the folded state, wherein the wingspan control system 416, 516a comprises a wing support frame 418, 518a configured to support the wing member 412, 512a; and a thrust unit 420, 520a configured to generate a thrust for rotating the rotorcraft 400, 500, wherein the flight controller 408, 508 is communicatively coupled to the thrust unit 420, 520a for controlling the thrust unit 420, 520a to control the flight of the rotorcraft 400, 500.

In various example embodiments, the rotorcraft 400, 500 is configured to operate as a rotating rotorcraft whereby the flight of the rotorcraft 400, 500 (e.g., lift thereof) is primarily achieved by rotating/spinning the entire rotorcraft 400, 500 (along with its wing(s) 412, 512a, 512b) about its yaw axis from the thrust generated by the thrust unit(s) 420, 520a, 520b.

Accordingly, the rotorcraft 400, 500 according to various example embodiments of the present invention is advantageously configured with adjustable wingspan, and more particularly, is capable of folding (or retracting) and unfolding (or expanding) its wing(s) during flight for enhancing the adaptability of the rotorcraft 400, 500 during flight and the usability/applicability of the rotorcraft 400, 500 for a wider range of practical applications.

In various example embodiments, the wing member 412, 512a comprises a plurality of wing panels 413, 513a arranged in series (successively in a direction in which the wing member 112 extends/expands as shown in FIGS. 4 and 5) and a plurality of foldable portions 414, 514a, each foldable portion 414, 514a being located between a corresponding pair of immediately adjacent wing panels 413, 513a. In other words, each pair of immediately adjacent wing panels 413, 513a is spaced apart by a corresponding foldable portion 414, 514a therebetween. Accordingly, each foldable portion 414, 514a is configured to be able to fold thereat (or foldable thereat) when the wing member 412, 512a is being folded by the wingspan control system 416, 516a.

In various example embodiments, the wing member 412, 512a is laminated with a film (e.g., a plastic film). In this regard, each portion of the film located between a corresponding pair of immediately adjacent wing panels 413, 513a forms the corresponding foldable portion 414, 514a located between the corresponding pair of immediately adjacent wing panels 413, 513a.

In various example embodiments, the wing support frame 418, 518a is coupled to the wing member 412, 512a at multiple foldable portions of the plurality of foldable portions 414, 514a and at a last wing panel of the plurality of wing panels 413, 513a for supporting the wing member 412, 512a and facilitating transitions of the wing member 412, 512a between the extended state and the folded state. As shown in FIGS. 4 and 5, the above-mentioned multiple foldable portions may be alternate foldable portions of the plurality of foldable portions 414, 514a. In various example embodiments, the wing support frame 418, 518a may be coupled to the above-mentioned multiple foldable portions via multiple hanger supports 422, 522a, respectively.

In various example embodiments, the wing support frame 418, 518a is arranged alongside a leading edge of the wing member 412, 512a and is configured to function as a guide rail for the plurality of wing panels 413, 513a. Accordingly, the wing support frame 418, 518a may be coupled to the above-mentioned multiple foldable portions 414, 514a and the above-mentioned last wing panel along the leading edge portion of the wing member 412, 512a. In various embodiments, as shown in FIGS. 4 and 5, the thrust unit 420, 520a is coupled to the wing support frame 418, 518a at a distal end portion thereof (e.g., distal end portion with respect to the housing member 104 as shown in FIGS. 4 and 5).

In various example embodiments, the wingspan control system 416, 516a is configured to fold the wing member 412, 512a in an accordion manner. For example, as described above, the wing member 412, 512a is configured to include the plurality of wing panels 413, 513a arranged in series and the plurality of foldable portions 414, 514a, whereby each pair of immediately adjacent wing panels 413, 513a is spaced apart by a corresponding foldable portion 414, 514a. Furthermore, in various example embodiments, the wing support frame 418, 518a of the wingspan control system 416, 516a is coupled to multiple (e.g., alternate) foldable portions 414, 514a along the leading edge portion of the wing member 412, 512a. In this manner, as the wing support frame 418, 518a retracts, the wing support frame 418, 518a is able to fold the wing member 412, 512a in an accordion manner. Similarly, as the wing support frame 418, 518a extends, the wing support frame 418, 518a is able to unfold the wing member 412, 512a in an accordion manner.

The first example rotorcraft 400 with adjustable wingspan corresponding to the FROW-P rotorcraft (i.e., in the case whereby the wingspan control system 416 is configured to passively or automatically control the wingspan of the wing member 412 during flight) will now be described in further details according to various example embodiments of the present invention.

In various example embodiments, the wingspan control system 416 further comprises a spring device 424 and a string 426 having a first end coupled to the spring device 424 and a second end coupled to the wing member 412 (e.g., at a distal end portion of the wing member 412 with respect to the spring device 424 or the housing member 404, such as at the last wing panel as shown in FIG. 4) for controlling the wingspan of the wing member 112. In this regard, the spring device 424 is configured to: when in the folded state, hold the wing member 412 in the folded state via the string 426 with a pre-loaded spring force pulling on the wing member 412 (e.g., at the distal end portion of the wing member 412 towards the spring device 424 or the housing member 404); and release the wing member 412 towards the extended state when the first example rotorcraft 400 is controlled by the flight controller 408 to rotate at a rotational speed which generates a centrifugal force which exceeds a spring force pulling on the wing member 412 produced by the spring device 424 via the string 426, thereby increasing the wingspan of the wing member 412 and storing elastic potential energy in the spring device 424. In other words, the spring device 424 is configured to release the wing member 412 towards the extended state when the centrifugal force generated by the rotating rotorcraft 400 overcomes the spring force pulling on the wing member 412.

In various example embodiments, the spring device 424 is configured to retract the wing member 412 towards the folded state when the first example rotorcraft 400 is controlled by the flight controller 408 to rotate at a rotational speed which generates a centrifugal force which is less than the spring force pulling on the wing member 412 produced by the spring device 424 via the string 426, thereby reducing the wingspan of the wing member 412. In other words, the spring device 424 is configured to retract the wing member 412 towards the folded state when the centrifugal force generated by the rotating rotorcraft 400 is less than (or not sufficient to overcome) the spring force pulling on the wing member 412. In various example embodiments, as shown in FIG. 4, the folded state is a fully folded state and the extended state is a fully extended state.

In various example embodiments, as shown in FIG. 4, the wing support frame 418 is a telescopic rod and the spring device 424 is a spiral spring device.

Accordingly, in various embodiments, the first example rotorcraft 400 is a monocopter.

The second example rotorcraft 500 with adjustable wingspan corresponding to the FROW-A rotorcraft (i.e., in the case whereby the wingspan control system 516a is configured to actively control the wingspan of the wing member 512a during flight) will now be described in further details according to various example embodiments of the present invention.

In various example embodiments, the wingspan control system 516a further comprises a servo motor 524a and a string 526a having a first end coupled to the servo motor 524a (e.g., via a spool) and a second end coupled to the wing member 512a (e.g., at a distal end portion of the wing member 512a with respect to the servo motor 524a or the housing member 504, such as at the last wing panel as shown in FIG. 5) for controlling the wingspan of the wing member 512a. In this regard, the servo motor 524a is configured to: retract, based on the servo motor 524a receiving a wingspan control input to retract, the wing member 512a towards the folded state by reeling in (e.g., via a spool) the string 526a (thereby pulling on the wing member 512a at the distal end portion thereof), thereby reducing the wingspan of the wing member 512a; and release, based on the servo motor 524a receiving a wingspan control input to release, the wing member 512a towards the extended state by releasing the string 526a for allowing the wing member 512a to extend towards the extended state via a centrifugal force produced when the second example rotorcraft 500 is being rotated, thereby increasing the wingspan of the wing member 512a. In other words, to expand the wing member 512a towards the extended state, the string 526a may be loosened so as to allow/enable the centrifugal force produced by the rotating rotorcraft 500 to extend the wing member 512a towards the extended state. In various example embodiments, as shown in FIG. 5, the folded state is a fully folded state and the extended state is a fully extended state.

In various example embodiments, the above-mentioned wing member 512a is (or corresponds to) a first wing member, the above-mentioned wingspan control system 516a is (or corresponds to) a first wingspan control system, and the above-mentioned thrust unit 520a is (or corresponds to) a first thrust unit. In this regard, in various example embodiments, the second example rotorcraft 500 further comprises: a second wing member 512b coupled to the housing member 504 at a second side thereof, wherein the second wing member 512b is configured to produce an aerodynamic force for generating a lift when the second example rotorcraft 500 is rotating and the second wing member 512b is in an extended state; a second wingspan control system 516b coupled to the housing member 504 and configured to control a wingspan of the second wing member 512b during flight between the extended state and a folded state, wherein the second wingspan control system 516b comprises a second wing support frame 518b configured to support the second wing member 512b; and a second thrust unit 520b configured to generate a thrust for rotating the second example rotorcraft 500, wherein the flight controller 508 is communicatively coupled to the second thrust unit 520b for controlling the second thrust unit 520b (together with the first thrust unit 520a) to control the flight of the second example rotorcraft 500. Accordingly, the second wing member 512b, the second wingspan control system 516b and the second thrust unit 520b may be configured in the same or corresponding manner as the first wing member 512a, the first wingspan control system 516a and the first thrust unit 520a, respectively, but are arranged with respect to (to extend from) the second side of the housing member 504 instead of the first side of the housing member 504. In various embodiments, as can be seen in FIG. 5, the first and second sides of the housing member 504 are opposite sides thereof.

Accordingly, in various example embodiments and in the same or corresponding manner as the first wing member 512a, the second wing member 512b comprises a plurality of wing panels 513b arranged in series and a plurality of foldable portions 514b, each foldable portion 514b being located between a corresponding pair of immediately adjacent wing panels 513b.

Accordingly, in various example embodiments and in the same or corresponding manner as the first wing member 512a, the second wing member 512b is laminated with a film (e.g., a plastic film). In this regard, each portion of the film located between a corresponding pair of immediately adjacent wing panels 513b forms the corresponding foldable portion 514b located between the corresponding pair of immediately adjacent wing panels 513b.

Accordingly, in various example embodiments and in the same or corresponding manner as the first wing support frame 518a, the second wing support frame 518b is coupled to the second wing member 512b at multiple foldable portions of the plurality of foldable portions 514b and at a last wing panel of the plurality of wing panels 513b for supporting the second wing member 512b and facilitating transitions of the second wing member 512b between the extended state and the folded state.

Accordingly, in various example embodiments and in the same or corresponding manner as the first wing support frame 518a, the second wing support frame 518b is arranged alongside a leading edge of the second wing member 512b and is configured to function as a guide rail for the plurality of wing panels 513b. Similarly, the second thrust unit 520b is coupled to the second wing support frame 518b at a distal end portion thereof.

Accordingly, in various example embodiments and in the same or corresponding manner as the first wingspan control system 516a, the second wingspan control system 516b is configured to fold the second wing member 512b in an accordion manner.

Accordingly, in various example embodiments and in the same or corresponding manner as the first wingspan control system 516a configured to actively control the wingspan of the first wing member 512a during flight, the second wingspan control system 516b comprises a servo motor 524b and a string 526b having a first end coupled to the servo motor 524b (e.g., via a spool) and a second end coupled to the second wing member 512b (e.g., at a distal end portion of the wing member 512b with respect to the servo motor 524a or the housing member 504, such as at the last wing panel as shown in FIG. 5) for controlling the wingspan of the second wing member 512b. In this regard, the servo motor 524b is configured to: retract, based on the servo motor 524b receiving a wingspan control input to retract, the second wing member 512b towards the folded state by reeling in (e.g., via a spool) the string 526b (thereby pulling on the wing member 512a at the distal end portion thereof), thereby reducing the wingspan of the second wing member 512b; and release, based on the servo motor 524b receiving a wingspan control input to release, the second wing member 512b towards the extended state by releasing the string 526b for allowing the second wing member 512b to extend towards the extended state via a centrifugal force produced when the second example rotorcraft 500 is being rotated, thereby increasing the wingspan of the second wing member 512b.

The wing 412, 512a, 512b will now be further described according to various example embodiments of the present invention. As described hereinbefore, in various example embodiments, the wing 412, 512a, 512b is designed in such a way to allow/enable an accordion-style folding. This allows the wing 412, 512a, 512b to obtain a reduction in length in the desired direction. As illustrated in FIGS. 4 and 5, the wing panels 413, 513a, 513b are configured to be foldable downwards, thereby allowing the rotorcraft 400, 500 to fold its wing(s) and reduce its footprint. For example, as shown in FIG. 5, the downwards folding allows the wing support frames 518a, 518b (e.g., carbon fiber rods) to extend across or over the wing panels 513a, 513b without being blocked by the wing panels 513a, 513b in the FROW-A rotorcraft 500. In a traditional accordion fold mechanism, hanger supports may be connected to the middle of the panels using a swivel mechanism. In contrast, various example embodiments attach the hanger supports 422, 522a, 522b to the foldable portions 414, 514a, 514b. This helps in simplifying the folding mechanism by removing the need for a swivel structure for the hanger supports. In various example embodiments, the wing support frame 418, 518a, 518b is configured to provide a firm support to the wing 412, 512a, 512b in flight and is able to retract to fold the wing 412, 512a, 512b as desired. In various example embodiments, the wing panels 413, 513a, 513b are arranged to keep sufficient gaps between each other for the foldable portions 414, 514a, 514b so as to spare enough room for attaching the hanger supports 422, 522a, 522b.

In various example embodiments, the wingspan control system 416, 516a, 516b comprises a wing support frame 418, 518a, 518b which functions as a guide rail (e.g., a carbon fibre rod) whereby connector supports (or hanger supports) 422, 522a, 522b are arranged to connect the wing panels 413, 513a, 513b to the guide rail 418, 518a, 518b. In various example embodiments, in both the FROW-P and FROW-A rotorcrafts 400, 500 as shown in FIGS. 4 and 5, the hanger supports 422, 522a, 522b are specifically affixed to alternate foldable portions 414, 514a, 514b so as to maintain such alternate foldable portions 414, 514a, 514b at the same level as the wing support frame 418, 518a, 518b during folding. As a result, the foldable portions 414, 514a, 514b not attached to any hanger support and is in between two foldable portions attached to hanger supports would fold down during folding. In various example embodiments, in case of the FROW-P rotorcraft 400, the wing support frame 418 has a telescopic configuration and has a first end portion affixed to the housing member 404 and a second end portion (which may be referred to as the distal end portion) affixed to the distal end portion of the of the wing 412 as shown in FIG. 4. Therefore, the wing support frame 418 is fixed at both its end portions. Therefore, when folding, the second end portion of the wing support frame 418 would be pulled towards the first end portion via the string 416 as shown in FIG. 4. On the other hand, when unfolding, the second end portion of the wing support frame 418 would move away from the first end portion via the string 416. In various example embodiments, in case of the FROW-A rotorcraft 500, the wing support frame 518a, 518b is not telescopic and is only fixed at its distal end portion. Therefore, when folding, the distal end portion of the wing support frame 518a, 518b would be pulled towards the housing member 504 and the other end portion would protrude out from the other side as shown in FIG. 5. Accordingly, the wing support frame 418, 518a, 518b acts as a guide rail for the wing panels 413, 513a, 513b which supports the folding mechanism span-wise such that the wing 412, 512a, 512b is guided to move only and stably in the spanwise direction during folding and unfolding. It will be appreciated by a person skilled in the art that the wing shape is not limited to any particular shape and may be configured or designed as desired or as appropriate as long as the rotorcraft 400, 500 is able to operate as a rotating rotorcraft. For example, the wing shape may be determined or configured via an optimization process for enhancing flight performance. As an example, the wing shape may be configured to mimic that of a samara seed as closely as possible to inherit the natural aerodynamic properties of the samara seed.

According to various example embodiments, the material for the wing 412, 512a, 512b is selected to attain a level of rigidity sufficient for producing advantageous aerodynamic forces when the wing 412, 512a, 512b is expanded, while simultaneously possessing adequate flexibility to facilitate folding. In this regard, the rigidity of different materials can be compared using Young's modulus. For example, the Young's modulus of balsa wood is higher than that of foam, and thus, balsa wood can withstand a higher rotational speed comparatively. As an illustrative example, for the wing panels 413, 513a, 513b, balsa wood panels (about 1 mm in thickness) are meticulously cut out and laminated using a thin plastic film. The folded-up wing 412, 512a, 512b may then be subjected to hot air (e.g., about 150 °C) which helps to thermally induce shape-memory effect of the folded position on the foldable portions 414, 514a, 514b to facilitate the folding of the wing panels 413, 513a, 513b during folding. The hanger supports 422, 522a, 522b may then be installed on (coupled to) selected foldable portions 414, 514a, 514b (e.g., alternate foldable portions as described herein according to various example embodiments), and the wing support frame 418, 518a, 518b may then be slotted in through the hanger supports 422, 522a, 522b coupled to the selected foldable portions 414, 514a, 514b, thereby mounting the wing 412, 512a, 512b on the wing support frame 418, 518a, 518b (e.g., carbon fiber rod). In case of the FROW-A 500 as shown in FIG. 5 according to various example embodiments, for example, the hanger supports 522a, 522b are slidable on the wing support frame 518a, 518b functioning as a guide rail, and thus the wing support frame 518a, 518b is slidably coupled to the wing 512a, 512b, thereby supporting the wing 512a, 512b thereon and the folding mechanism span-wise. Furthermore, as shown in FIG. 5, the wing support frame 518a, 518b at the distal end portion thereof is fixed to the distal end portion of the wing 512a, 512b and the thrust unit 520a. In case of the FROW-P 400 as shown in FIG. 4 according to various example embodiments, the wing support frame 418 is a telescopic rod configured such that it does not protrude out from the opposite side of the housing member 404 as the wing 412 is being folded. For example, the number of collapsible sections of the telescopic rod 418 is configured to based on the desired number of folds in the wing 412 during folding or based on the number of hanger supports 422 connected to the wing 412. As an illustrative example, as shown in FIG. 4, the telescopic rod 418 has a first or main section and five collapsible sections which is collapsible into (or within) the previous section. The first or main section is affixed to the housing member 404 and a first hanger support 422 is affixed (e.g., firmly attached via glue) to an end of the first hanger support 422 as shown in FIG. 4. Similarly, the first collapsible section (collapsible into the main section) has a second hanger support affixed to an end thereof, the second collapsible section (collapsible into the first collapsible section) has a third hanger support affixed to an end thereof, and so on. The last collapsible section does not have a hanger support affixed thereto but both the thrust unit 420 and the distal end portion of the wing 412 are affixed thereto as shown in FIG. 4.

In various example embodiments, the second example rotorcraft 500 (corresponding to the FROW-A rotorcraft) is designed such that each wing 512a, 512b only folds/collapses by up to about 40% of its total (i.e., maximum) wingspan, leaving available wingspan of at least about 60% of its maximum wingspan at the folded state (or folded mode) for generating aerodynamic lift when the rotorcraft 500 is being rotated. Accordingly, this design for the FROW-A rotorcraft helps to ensure adequate wing area remains available for lift generation while the wings 512a, 512b are folded. From experimentations conducted, it was observed that using only a single wing may cause the FROW-A rotorcraft's rotational speed to be extremely high and may thus place significant stress on the actuators (both the motor and servo components). To overcome this technical challenge and alleviate pressure on the actuators, according to various example embodiments, two wings 512a, 512b are incorporated into the FROW-A rotorcraft 500 as shown in FIG. 5 instead of one wing to maximize aerodynamic lift production in the folded mode. As shown in FIG. 5, each wing 512a, 512b overlaps with the other wing support frame 518a, 518b protruding out from the other side of the housing member (e.g., central hub) 504 in the folded state which advantageously optimizes the use of available space.

In various example embodiments, the first example rotorcraft 400 (corresponding to the FROW-P rotorcraft) is designed to be capable of achieving a reduction in the wingspan (wing surface area) passively through a wingspan control system 416 comprising a spiral spring 424. In various example embodiments, the wing 412 is configured to fold/collapse by up to about 70% of its total (i.e., maximum) wingspan. With this configuration, when the wing 412 is in the folded state, the wing 412 is unable to generate sufficient lift for the monocopter flight, thereby putting the rotorcraft (the FROW-P rotorcraft) 400 in the dive mode. As observed in the configuration of the FROW-A rotorcraft 500 shown in FIG. 5, the dual wings 512a, 512b overlap with the wing support frames 518a, 518b, respectively, in the folded state. In contrast, in various example embodiments, the FROW-P 400 is configured to avoid/minimise extra portions of the wing support frame 418 protruding out (beyond the housing member 404). In this regard, in various example embodiments and as described above, a telescopic rod is employed as the wing support frame 418 as depicted in FIG. 4. The telescopic mechanism is mechanically sufficiently rigid to avoid twisting of the wing 412 whilst being smooth in its motion when retracting/collapsing to fold the wing 412 or expanding to unfold the wing 412. As shown in FIG. 4, the wing support frame 418 may be coupled to (or affixed to) the housing member 404 at a main or beginning section thereof from which the wing support frame 418 is extendable.

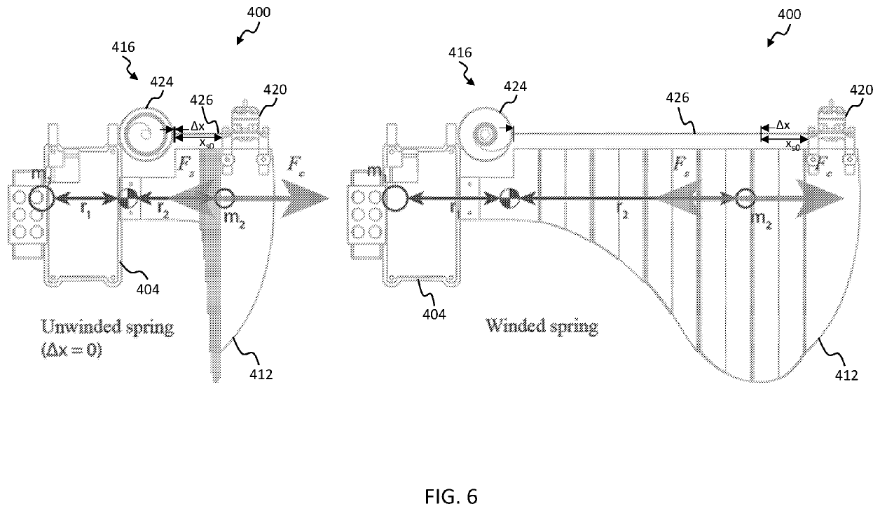

The contraction and expansion (or folding and unfolding) of the wing 412, 512a, 512b will now be further described according to various example embodiments of the present invention. For the passively controlled FROW-P rotorcraft 400, in various example embodiments, the folded wing 412 is held in tension using a spiral spring 424. FIG. 6 depicts a schematic drawing illustrating the unwinded (corresponding to the expanded state) and winded (corresponding to the folded state) spring model for the FROW-P rotorcraft 400. In particular, FIG. 6 illustrates the modelling of the spiral spring force and the centrifugal force of the FROW-P rotorcraft 400. In the unwinded and winded spring model, the cross-section of the spiral spring 424 is assumed to be rectangular and its thickness is even throughout its length. Furthermore, it is assumed that the string 426 used for the folding mechanism is not elastic. For better understanding, FIG. 6 shows a displacement parameter Δx and a minimum displacement parameter xₛ₀. The minimum displacement parameter xₛ₀ denotes the length of the string 426 when the wing 412 is at the folded state (e.g., when the wing 412 is fully folded/collpased). Therefore, the total length of the string 426 is xₛ₀ when the wing 412 is fully folded/collapsed and xₛ₀+Δx when as the wing is being expanded by Δx.

In various example embodiments, the spring force Fₛ is determined or estimated as follows:

Fₛ=KₛΔx+Fₛ₀ (Equation 1)
where Kₛ denotes the spring constant, Δx denotes the displacement of the string, and Fₛ₀ denotes the pre-loaded spring force.

The centrifugal force F_{c} acting on the FROW-P rotorcraft 400 can be estimated by approximately dividing the rotorcraft 400 into two parts about the center of rotation as shown in FIG. 6 and as follows:

$${F}_{c} = {m}_{1} {Ω}_{Z}^{2} {r}_{1} = {m}_{2} {Ω}_{Z}^{2} {r}_{2} \qquad ( Equation 2 )$$

where m₁ and m₂ denote lumped masses located at distances r₁ and r₂ from the center of mass of the rotorcraft 400, respectively, and Ω_{z} denotes the rotational speed of the FROW-P rotorcraft 400. Accordingly, to calculate the centrifugal force F_{c} acting on the FROW-P rotorcraft 400, two lumped masses m₁ and m₂ are considered at distance r₁ and r₂ from the center of mass. It is assumed that the mass m₁ depicted in FIG. 6 is identical for both unwinded and winded spring 424. This is because the distance r₁ of mass m₁ from the center of mass does not change significantly in both cases. In other words, since the whole body rotates uniformly, the centrifugal force F_{c} experienced by mass m₂ will be equal to that of mass m₁.

Accordingly, from the spring model for the FROW-P rotorcraft 400 shown in FIG. 6, it can be seen that the balance of forces between the spring force Fₛ and the centrifugal force F_{c} acting on the FROW-P rotorcraft 400 determines the state of the wing 412, and thus the state of the flight, of the FROW-P rotorcraft 400 as follows:

To fly F_{c}>Fₛ

To fold F_{c}<Fₛ (Equation 3)

Accordingly, the spring device 424 is configured to: when in the folded state, hold the wing 412 in the folded state via the string 426 with a pre-loaded spring force Fₛ₀ pulling on the wing 412 (e.g., at the distal end portion of the wing member 112 towards the spring device 424 or the housing member 404); and release the wing 412 towards the extended state when the rotorcraft 400 is controlled by the flight controller 408 to rotate at a rotational speed which generates a centrifugal force F_{c} which exceeds a spring force Fₛ pulling on the wing 412 produced by the spring device 424 via the string 426, thereby increasing the wingspan of the wing 412 and storing elastic potential energy in the spring device 424. Therefore, when the rotorcraft 400 spins at a rotational speed which generates a centrifugal force F_{c} which exceeds the spring force Fₛ acting on the wing 412, the wingspan control system 416 expands the wing 412 outwards. On the other hand, when the centrifugal force F_{c} generated by the rotating rotorcraft 400 is less than (or not sufficient to overcome) the spring force Fₛ pulling on the wing member 412, the wing 412 is retracted towards the folded state based on the elastic potential energy stored in the spring device 424.

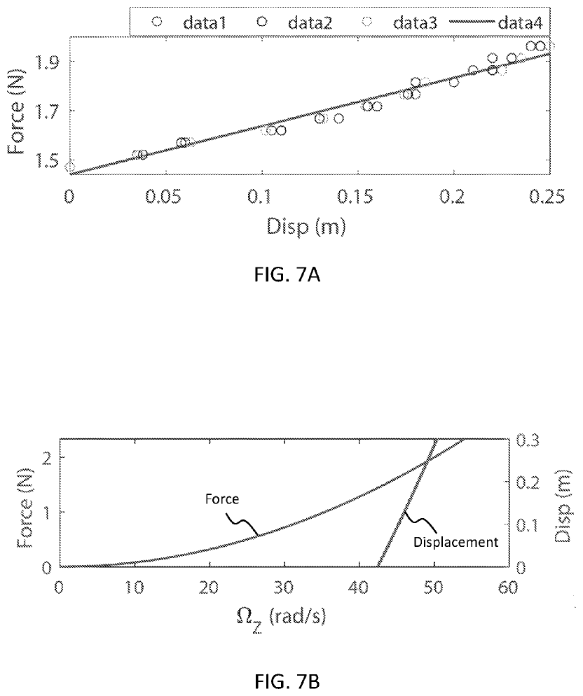

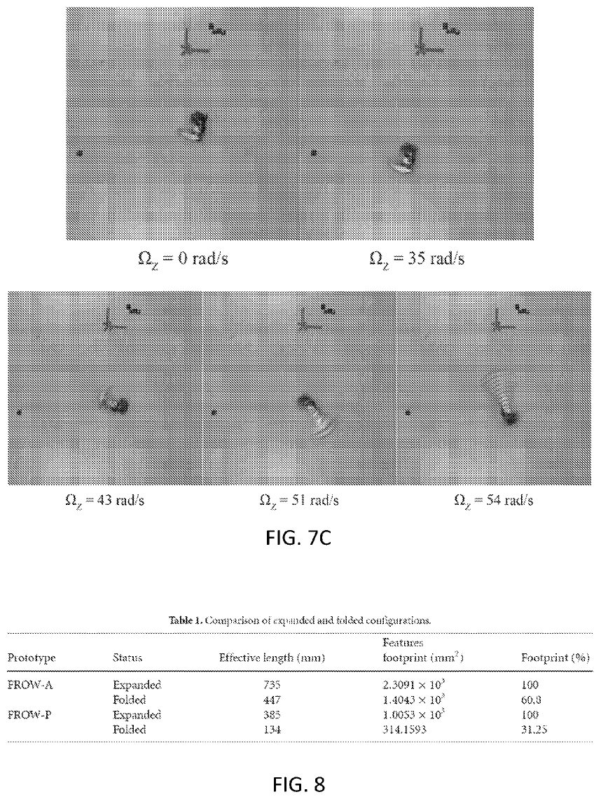

For example, the constant Kₛ of the spiral spring 424 may be approximated by experimentation where a set of weights are used to measure the extension in the length of the string 426 under different loading conditions. In experiments conducted, the mechanical properties of different, readily available, springs were tested for the selection of an appropriate spiral spring which can provide the desired results. FIGS. 7A to 7C show the results of the experiments performed from three different trials. In particular, FIG. 7A shows a plot of experimental data showing the displacement Δx of the string subjected to different loads. FIG. 7B shows a plot illustrating the approximation of the centrifugal force F_{c} as the rotational speed Ω_{z} changes based on the centrifugal force formula (Equation 2) along with the relationship between the rotational speed Ω_{z} and the string displacement Δx obtained theoretically. In other words, FIG. 7B shows the relation between the rotational speed Ω_{z} and the centrifugal force F_{c}, approximated using Equation 2. From FIG. 7A, the regression line shows that there is nearly a linear relationship between the force applied and the displacement Δx of the string.

Considering a hypothetical equilibrium, where the forces F_{c} and Fₛ are equal, a relation between the rotation speed Ω_{z} and the displacement Δx of the string can be determined as follows:

$$m {Ω}_{Z}^{2} r = {K}_{s} Δ x + {F}_{s 0} \qquad ( Equation 4 a )$$

$${Ω}_{z} = \sqrt{\frac{{K}_{s} Δ x + {F}_{s 0}}{m r}} \qquad ( Equation 4 b )$$

As mentioned above, FIG. 7B shows a plot presenting the theoretical relationship between the rotation speed Ω_{z} and the displacement Δx of the string. Experiments were conducted using the FROW-P prototype 400 for verification of this relationship. As depicted in the frames captured of the flight in FIG. 7C, it can be seen that the experimental results followed the relationship closely. Accordingly, FIG. 7C shows experimental proof of the relationship obtained depicting the FROW-P rotorcraft 400 rotating at various rotational speeds during the flight. It can also be observed that the centrifugal force F_{c} acting on the FROW-P rotorcraft 400 overcomes the spring force Fₛ at around 43 rad/s and achieves full extension (i.e., the extended state) at 54 rad/s.

For the actively controlled FROW-A rotorcraft 500, in various example embodiments, the FROW-A rotorcraft 500 employs a servo motor 524a, 524b to fold the respective wing 512a, 512b. The servo 524a, 524b may be connected to a spool, which reels in the string 526a, 526b connected to the other side (distal end portion) of the wing 512a, 512b, thereby pulling on the wing 512a, 512b at the distal end portion thereof to fold the wing 512a, 512b. For the expansion of the wing 512a, 512b, the servo 524a, 524b relaxes the string 526a, 526b, and the rotating wing 512a, 512b expands under the influence of the centrifugal force experienced by the wing 512a, 512b and the wing support frame 518a, 518b attached to the wing 512a, 512b. Accordingly, the servo 524a, 524b is configured to: retract, based on the servo 524a, 524b receiving a wingspan control input to retract, the wing 512a, 512b towards the folded state by reeling in the string 526a, 526b via a spool, thereby reducing the wingspan of the wing 512a, 512b; and release, based on the servo 524a, 524b receiving a wingspan control input to release, the wing 512a, 512b towards the extended state by releasing the string 526a, 526b for allowing the wing 512a, 512b to extend towards the extended state via a centrifugal force produced when the rotorcraft 500 is being rotated, thereby increasing the wingspan of the wing 512a, 512b. In various example embodiments, the flight controller 508 (e.g., based on a Teensy microcontroller) may be configured to send the wingspan control input to the servo 524a, 524b upon receiving the corresponding control input, for example, from a user or operator. In various example embodiments, the length/amount of the wing 512a, 512b to be folded in the folded state is determined or designed to leave sufficient wing surface area to support the flight of the FROW-A rotorcraft 500 in the folded state, which may be determined based on experimentation. As an illustrative example, the FROW-A rotorcraft 500 may be designed such that each wing 512a, 512b only folds/collapses by up to about 40% of its total (i.e., maximum) wingspan, leaving available wingspan of at least about 60% of its maximum wingspan at the folded state (or folded mode) for generating aerodynamic lift when the rotorcraft 500 is being rotated.

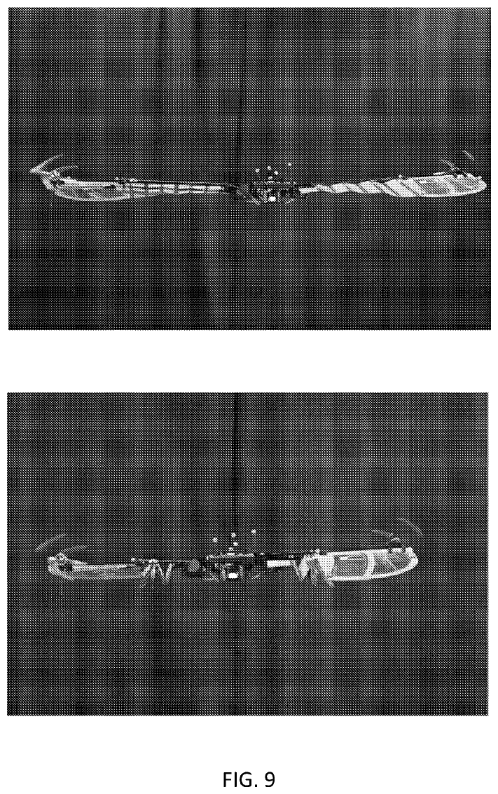

As an example illustration, FIG. 8 shows a table (Table 1) comparing various example dimensions of the expanded and folded configurations for the first and second example rotorcrafts (FROW-P and FROW-A rotorcrafts) 400, 500 according to various example embodiments of the present invention. For example, FIG. 9 shows images of the second example rotorcraft (the FROW-A rotorcraft) 500 in flight in the extended state (top image) and the folded state (bottom image).

According to various example embodiments, the rotorcraft 400, 500 operates based on a flight controller 408, 508 (or a flight controller system, which may be custom-built) which may be controlled by a human operator or through a closed-loop feedback position controller on a computer in a motion-capture environment. For example, the flight controller 408, 508 may be based on a Teensy microcontroller which may have an inbuilt memory card reader (e.g., a micro SD card reader) for data-logging capability. For the heading reference, a high-performance three-axis magnetometer may be employed on board for control in an open loop. In various example embodiments, all electronic components such as the flight controller 408, 508, receivers, magnetometer, power regulator, and electronic speed controllers (ESCs) are arranged and soldered on a Printed Circuit Board (PCB) (e.g., a custom-designed PCB), which is disposed (e.g., mounted) on a housing member 404, 504 (e.g., 3D printed central hub) of the rotorcraft 400, 500. The housing member 404, 504 also houses a power source (e.g., a Li-Po battery) for powering the rotorcraft 400, 500 and may be configured or shaped as desired or as appropriate.

### Dynamic Modeling and Control

The dynamic modeling of the example rotorcraft 400, 500 and the flight controller 408, 508 applied to control a flight of the example rotorcraft 400, 500 (e.g., to obtain altitude and transitional control of the example rotorcraft 400, 500) will now be described according to various example embodiments of the present invention.

### Dynamic Modelling

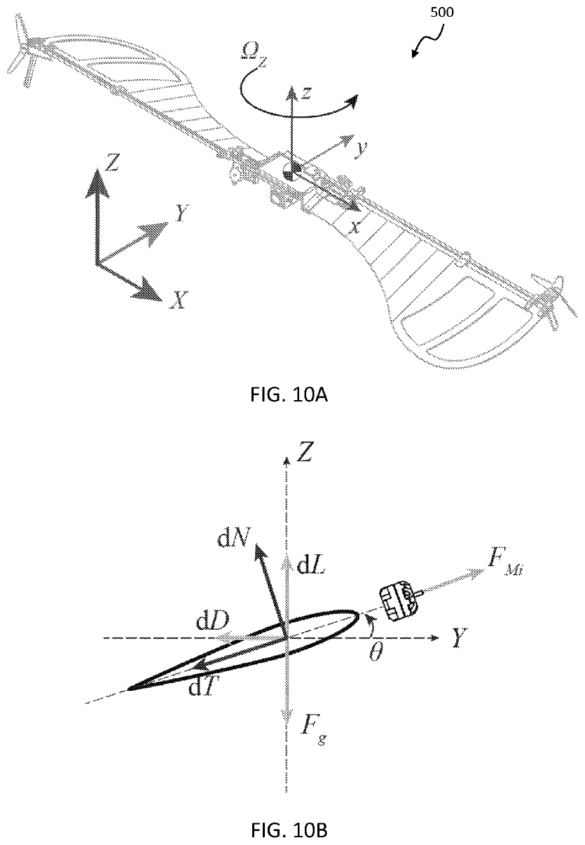

As an illustrative example, FIG. 10A depicts a schematic drawing of the example rotorcraft 500, along with the inertial reference frame (X, Y, Z), the body reference frame (x, y, z) and the direction of rotation 222. Although the dynamic modelling and the flight controller are described with respect to the example rotorcraft 500 as an illustrative example, they also apply to the example rotorcraft 400 in the same or corresponding manner. The body-frame x-axis is considered along the wingspan, the z-axis is considered perpendicularly upwards, and the y-axis completes the triad according to the right-hand rule. FIG. 10B depicts a schematic drawing of an example single blade element of the example rotorcraft 500, along with representation of aerodynamic forces on the single blade element. Accordingly, as depicted in FIG. 10A, a right-handed inertial reference frame is defined using (X, Y, Z)∈I and the body reference frame attached to the Centre of Gravity (CG) is defined using (x, y, z)∈B. Using the Newton-Euler formulation, the translational dynamics of the rotorcraft 500 can be expressed as:

$$m \ddot{p} = {R}_{B}^{I} {F}^{B} + m G \qquad ( Equation 5 )$$

where p^{l}=[p_{X}, p_{Y}, p_{Z}] is the position vector in the inertial frame,

$${R}_{B}^{I}$$

represents the rotational transformation from body-frame to inertial-frame, F^{B}=[Fₓ, F_{y}, F_{z}]^{T} is the force vector, and G=[0,0, g]^{T} is the gravity vector.

Similarly, the attitude dynamics equation of the example rotorcraft 500 can be expressed as:

$${I}^{B} {\dot{ω}}^{B} + {ω}_{\times }^{B} {I}^{B} {ω}^{B} = {τ}^{B} \qquad ( Equation 6 )$$

where I^{B}∈R^{3×3} is the inertia matrix, ω^{B} is the angular velocity in the body frame, and τ^{B}=[τₓ, τ_{y}, τ_{z}]^{T} is the torque vector.

The aerodynamic forces acting on the wing are modeled with the Blade Element Theory (BET). Under the BET, the wing surface is split into n blade elements, and the overall lift and drag contributions are obtained by summing up the individual contributions. The lift and drag force contribution from each blade element may be calculated as follows:

$$d L = \frac{1}{2} {C}_{l} ρ {U}^{2} c d r , d D = \frac{1}{2} {C}_{d} ρ {U}^{2} c d r \qquad ( Equation 7 )$$

where Cₗ and C_{d} denote the lift and drag coefficients respectively, ρ denotes the density of air, U denotes the relative air velocity encountered at the tip of the blade element (i.e., velocity of the oncoming air encountered by the tip of the blade element), c is the chord length of each blade element, and dr is the width of each blade element. dL and dD can be resolved into normal and tangential forces as follows:

dN=dL cos θ+dD sin θ,dT=dL sin θ−dD cos θ (Equation 8)
where θ is the pitch angle between the relative air velocity and wing, as shown in FIG. 10B.

### Cyclic Control

According to various example embodiments, the attitude of the example rotorcraft 500 is governed by a cyclic control. Contrary to the swash plate mechanism, the thrust units 520a, 520b are used to provide a periodic thrust, which controls the roll and pitch of the rotorcraft 500. For example, the cyclic control implemented may be based on a square cyclic control technique, such as that disclosed in Bhardwaj et al., “P.I.D. based Sliding Mode Control of Asynchronous Multi-actuator Monocopter”, 2021 IEEE/ASME International Conference on Advanced Intelligent Mechatronics (AIM), pp 239-246, 2021.

The amplitude of the cyclic command, Tₐₘₚ, is mapped to the amplitude of the roll and pitch input, φ_{c} and θ_{c} respectively. Tₐₘₚ and the direction control variable ψ_{c} of pitch and roll input are calculated as:

$${ψ}_{c} = a tan 2 ( \frac{{ϕ}_{c}}{{θ}_{c}} ) , {T}_{amp} = {k}_{c} \sqrt{{ϕ}_{c}^{2} + {θ}_{c}^{2}} \qquad ( Equation 9 )$$

where k_{c} is a constant to scale the effectiveness of roll and pitch actuation commands. The cyclic commanded thrust for the thrust unit 520a, 520b includes both the altitude correction (collective thrust) as well as direction correction (cyclic thrust), and may be computed as:

$${T}_{cyc} = \{ \begin{matrix}{T}_{o} + {T}_{amp} , & if sin ( ψ + {ψ}_{c} + {ψ}_{0} ) > ϵ \\ {T}_{o} - {T}_{amp} , & otherwise\end{matrix} \qquad ( Equation 10 )$$

where Tₒ denotes the thrust offset for maintaining altitude, ψ denotes the current azimuth heading, ψ₀ denotes the offset value for angular correction induced due to gyroscopic precision and other effects, and ε denotes the variable to control the duty cycle. In a manual flight, Tₒ is mapped directly to the throttle value from a radio controller. Likewise, the roll and pitch inputs required to calculate Tₐₘₚ are mapped directly to the roll and pitch stick, respectively.

In various example embodiments, to conduct experiments in a motion capture environment, a closed-loop flight controller is designed, including an attitude stabilizer control and a position controller.

### Attitude Control

The example rotorcraft 500 is affected by both aerodynamic forces and gyroscopic precession, similar to other rotating platform aerial vehicles. Similar to them, the example rotorcraft 500 has a natural precession circle that can either grow (unstable), remain constant (marginally stable), or decrease (stable) depending on the physical characteristics. Ideally, the physical dynamics of a rotating rotorcraft should be set up so that the precession circle decreases without any control input. This seeks to ensure that when a disturbance occurs, the rotorcraft would fly in spirals with decreasing radius. For example, various example embodiments note that the design of the example rotorcraft 500 may lead to unsteady precession motion, and changing the wingspan mid-flight alters the moment of inertia, which may result in further instability. To address this potential instability issue, various example embodiments provide a proportional attitude stabilizer controller configured to regulate the precession motion to achieve a stable flight.

In various example embodiments, the attitude stabilizer control command may be generated as:

u_{ac}=−k_{ac}·Ω (Equation 11)
where k_{ac} denotes a positive gain matrix and Ω denotes the angular velocity vector. Through this stabilization, the undesired angular velocities in the pitch and roll axis can be damped out. Since the attitude stabilization of the example rotorcraft 500 is desired in the roll and pitch axis only, u_{ac} [3] can be ignored. The effect of attitude stabilization will be further explained later below, along with the experimental results.

### Position Control

In various example embodiments, the position controller of the example rotorcraft 500 is based on the Sliding Mode Control (SMC) method. The sliding surface s may be defined using the error in position as well as velocity to keep control over both states as follows:

s=kₚ(p_{d}−p)−kᵥv (Equation 12)
where kₚ and kᵥ are the sliding surface gains matrices for the position and velocity components, respectively.

The control law may then be defined using standard SMC method (e.g., as described in Gao et al., “Variable structure control of nonlinear systems: A new approach”, IEEE Transactions on Industrial Electronics, vol. 40, no. 1, pp. 45-55, February 1993) as follows:

u=C·sat(s) (Equation 13)
where C is the gain matrix, and sat(·) is a saturation function defined as,

$$sat ( . ) = \{ \begin{matrix}sin ( . ) , & if \vert s \vert > {s}_{ϕ} \\ s / {s}_{ϕ} , & otherwise\end{matrix} \qquad ( Equation 14 )$$

where s_{φ} is the boundary layer thickness of the sliding surface.

The final control input for roll and pitch in the cyclic controller may then be obtained by combining the controller outputs for roll and pitch axis from the attitude stabilizer control and position control as follows:

$$[ \begin{matrix}{ϕ}_{c} \\ {θ}_{c}\end{matrix} ] = [ \begin{matrix}u [ 2 ] + {u}_{ac} [ 2 ] \\ u [ 1 ] + {u}_{ac} [ 1 ]\end{matrix} ] \qquad ( Equation 15 )$$

and Tₒ=u[3]. The obtained roll and pitch commands from Equation (15) may then be fed into Equation (9) to obtain motion in desired axis.

### Experimental Results

The experimental setup used for conducting the indoor experiments for the example FROW-A rotorcraft (or prototype) 500 will now be described, along with the experimental results obtained for closed loop waypoint and trajectory tracking in both extended and folded configurations (extended and folded states). Furthermore, the outdoor experiments conducted for the example FROW-P rotorcraft (or prototype) 400 will be described along with the experimental results obtained.

The experiments were conducted in a motion-capture environment to verify the position control of the example FROW-A rotorcraft 500. The motion-capture cameras captured the position and attitude of the reflective markers mounted on the FROW-A prototype 500. This position and attitude data was then sent to a computer running the controller code, which computes the output commands for actuators. The outputs for motors and servos were sent through Wi-Fi to the FROW-A rotorcraft 500. A second RC receiver under a human operator's control was also able to send control signals to the FROW-A rotorcraft 500, which can overrule the output commands from the computer if desired.

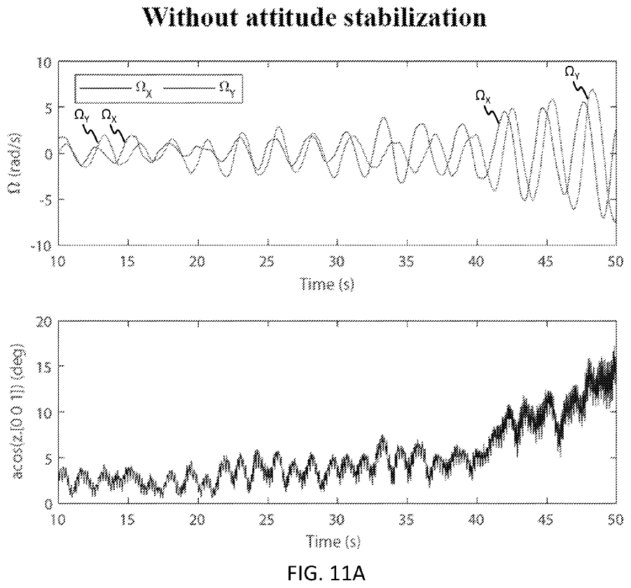

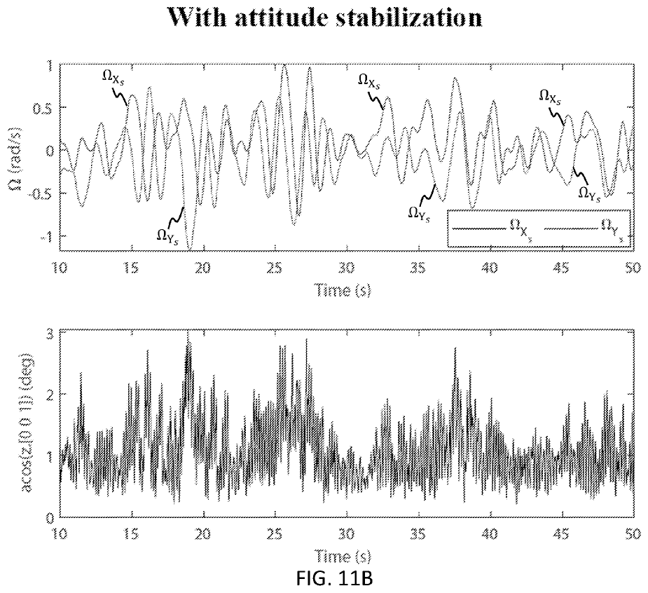

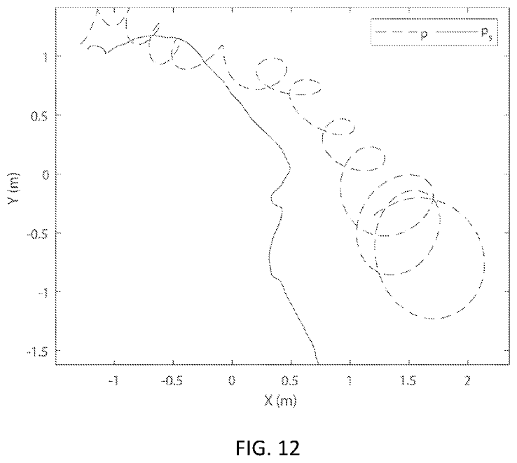

In order to evaluate the impact of the attitude stabilizer on the flight performance, the example FROW-A rotorcraft 500 was commanded to hover at a designated altitude, both with and without the controller engaged. The obtained results are presented in FIGS. 11A and 11B. In particular, FIGS. 11A and 11B show experimental results showing the effect of attitude control on the flight without attitude stabilization (FIG. 11A) and with attitude stabilization (FIG. 11B). The top image in each of FIGS. 11A and 11B shows a plot of the angular velocities over time in the X and Y axis, and the bottom image in each of FIGS. 11A and 11B shows a plot of the angle over time between the body-frame z and the world-frame Z. During flights without attitude stabilization, it was observed that the example FROW-A rotorcraft 500 experienced unstable motion, characterized by the increasing angular velocity of the X and Y axes, as illustrated in FIG. 11A. A second plot was generated to represent the deviation of the Tip Path Plane (TPP) relative to the world frame. This was achieved by plotting the angular difference between the body-frame z-axis and the world frame Z-axis. As can be seen from FIG. 11B, the use of attitude control resulted in a stable flight with no uncontrollable procession motion. FIG. 12 depicts a plot of the experimental results showing the position of the example FROW-A rotorcraft 500, with (ps) and without (p) the attitude controller. The drift observed during the flight is due to the absence of position control. Therefore, FIG. 12 shows the position of the example FROW-A rotorcraft 500 demonstrating the precession motion without the attitude controller.

### Closed-loop Waypoint Tracking

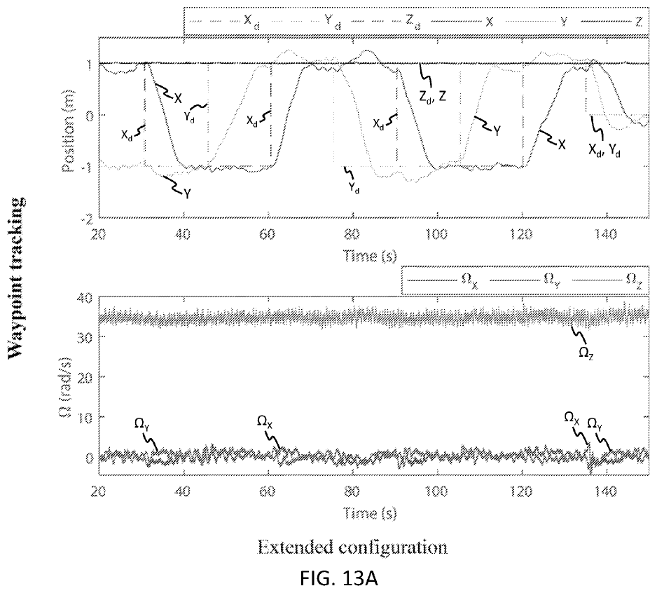

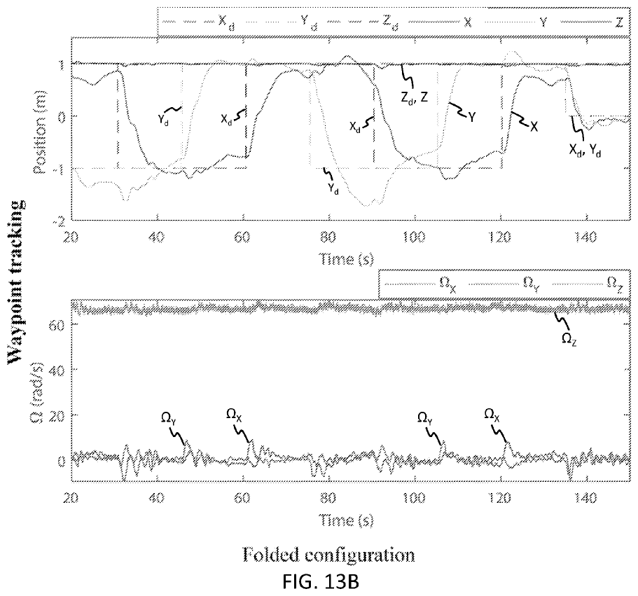

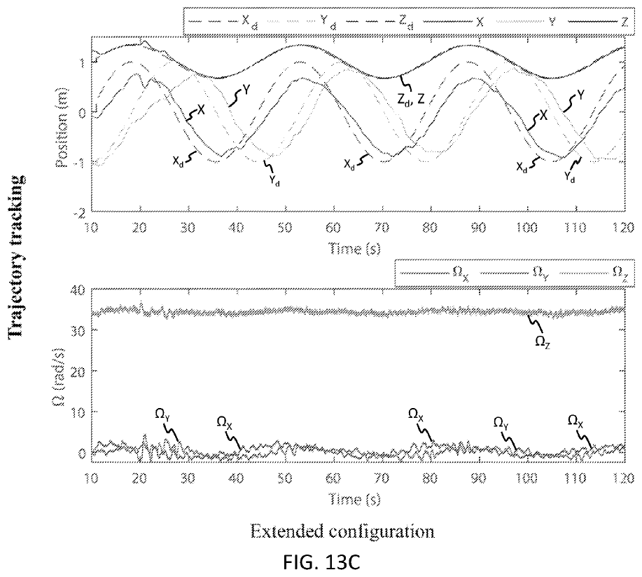

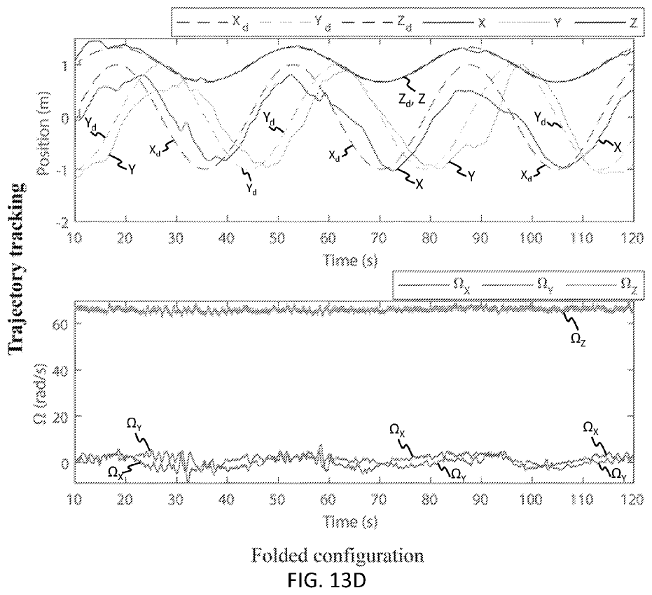

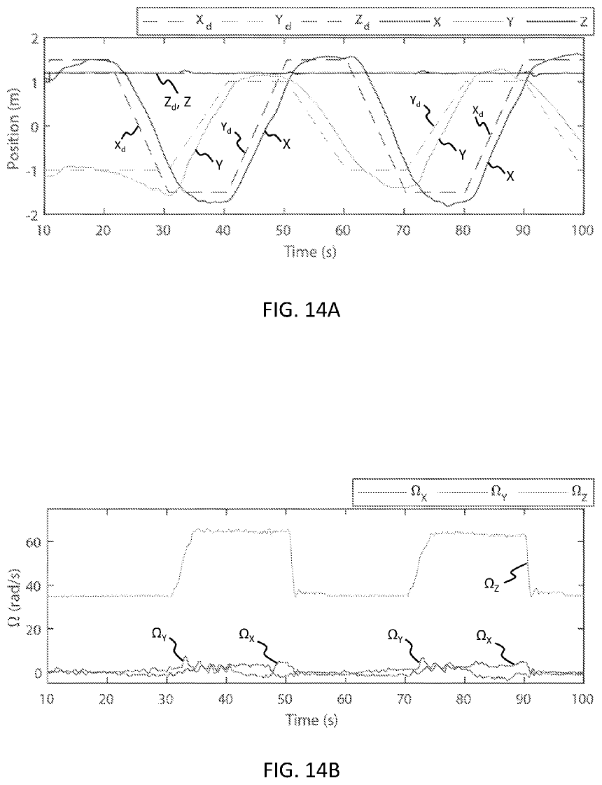

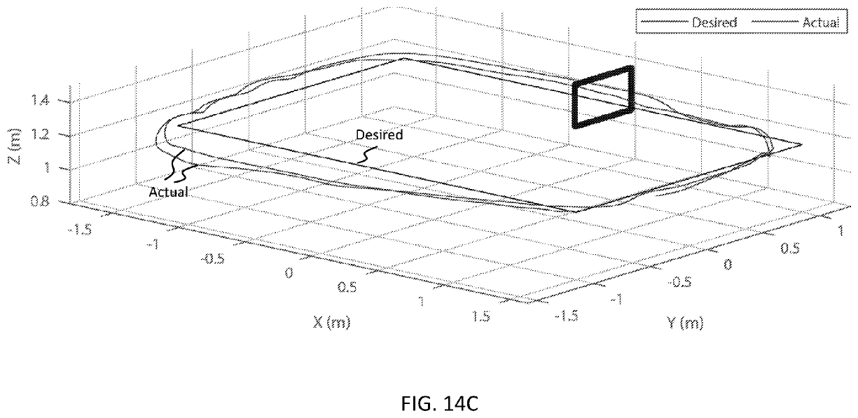

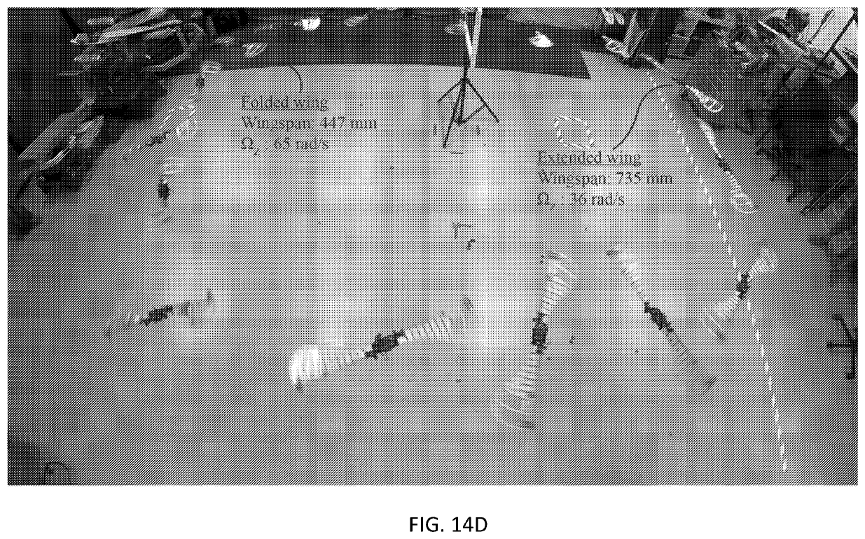

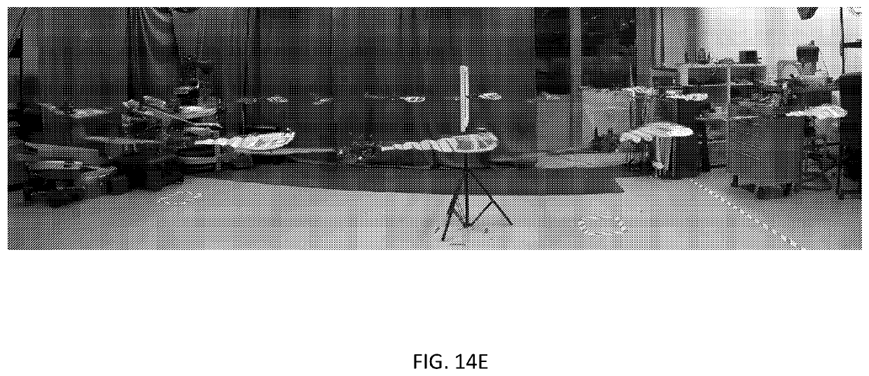

To test the closed-loop waypoint tracking of the example FROW-A rotorcraft 500, the rotorcraft was tasked to fly towards waypoints forming a square shape of 2 m sides. Each waypoint was set for a 20-second interval. FIGS. 13A and 13B depict plots of the closed-loop waypoint results for the example FROW-A rotorcraft 500 obtained for the extended and folded configurations. Alongside the position plots, Ω_{X}, Ω_{Y}, Ω_{Z} are also plotted as shown. From FIGS. 13A and 13B, it can be observed that both the extended and folded configurations performed well for the waypoint experiment, however, the folded configuration tends to overshoot the waypoint more compared to the extended configuration. This can be attributed to the higher angular momentum of the rotorcraft in the folded state due to its higher Ω_{Z}. Spikes in Ω_{X} and Ω_{Y} can be observed in both the extended and folded configurations where the waypoints have moved to a new position due to the change in the tip path plane of the rotorcraft. In FIGS. 13A to 13D and FIGS. 14A and 14B, X_{d}, Y_{d}, Z_{d} denote the desired positions in the three axes and X, Y, Z denote the actual/measured position of the rotorcraft.

### Closed-Loop Trajectory Tracking

To test the closed-loop trajectory tracking of the example FROW-A rotorcraft 500, the rotorcraft was tasked to fly in a helical trajectory, where the position in X, Y, and Z axes was changed continuously. A 1 m radius circle was traced in the X and Y axes, changing the desired position incrementally at each time step. FIGS. 13C and 13D depict plots of the trajectory tracking results for the example FROW-A rotorcraft 500 obtained for the extended and folded configurations. Overall, both extended and folded configurations produced satisfactory results while tracking the trajectory. Similar to waypoint tracking, a higher angular velocity in the Z axis can be observed for the folded configuration. In certain instances (for example, around 30 seconds and 60 seconds), some peaks can be observed for the folded configuration, which can be associated with the controller trying to correct the position.

### Flight Test for Contraction and Expansion of the Wing

To test the contraction and expansion mechanism of the wing during the flight, several manual flight tests were performed. The wing was commanded to fold and expand fully, and the flight characteristics were observed. It was observed that the example FROW-A rotorcraft 500 took about 3 seconds to fully fold and extend its wings at the maximum folding and unfolding speed achievable using the servos employed.

Experiments were also performed to test the mechanism's performance while tracking a square-shaped trajectory. To demonstrate the maneuverability of the example FROW-A rotorcraft 500, a rectangular cutout in the shape of a narrow window (0.5 m×0.4 m) was placed along one of the edges of the square. FIGS. 14A to 14C show the performance of the example FROW-A rotorcraft 500 during the experiment, and FIGS. 14D and 14E show selected frames extracted from a video depicting the example FROW-A rotorcraft 500 passing through the narrow window during the experiment from a top view (FIG. 14D) and a side view (FIG. 14E). In particular, FIGS. 14A and 14B show plots of experimental results showing the position (FIG. 14A) and the attitude (FIG. 14B) of the example FROW-A rotorcraft 500 passing through the narrow window. FIG. 14C shows a 3D plot of the trajectory followed by the example FROW-A rotorcraft 500 during the experiment. It was observed that while transitioning from the expanded to the folded configuration, the altitude of the example FROW-A rotorcraft 500 experienced some perturbations. This may be removed by further tuning of the controller and the PWM offset value of motors.

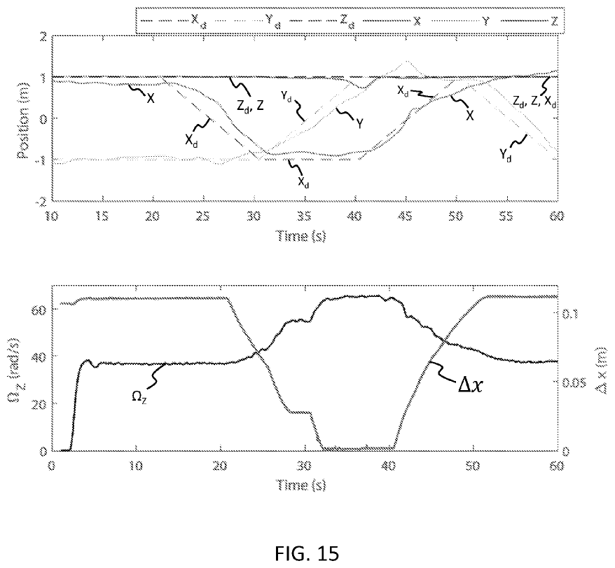

The performance of the example FROW-A rotorcraft 500 was tested by gradually changing the wingspan over a longer duration of time to ensure that the rotorcraft was controllable at any length of wingspan possible with the wing folding mechanism. FIG. 15 shows plots of the experimental results showing the position control along with the angular velocity and displacement Δx of the wingspan of the example FROW-A rotorcraft 500. A gradual increase and decrease in the rotation speed can be observed as the wings are folded in and expanded in a 15-sec duration. For this experiment, the angular velocity increased from around 36 rad/s at maximum wingspan to around 65 rad/s at minimum wingspan. The position graph shows that the example FROW-A rotorcraft 500 successfully followed the trajectory during the experiment. To avoid extra current being drawn by the continuous servos, they were operating at 80% of their maximum power. However, once they reach their maximum performance limit at this level, the power was changed to 100%. This leads to a sudden change in the displacement Δx, which can be observed around 30 seconds into the experiment.

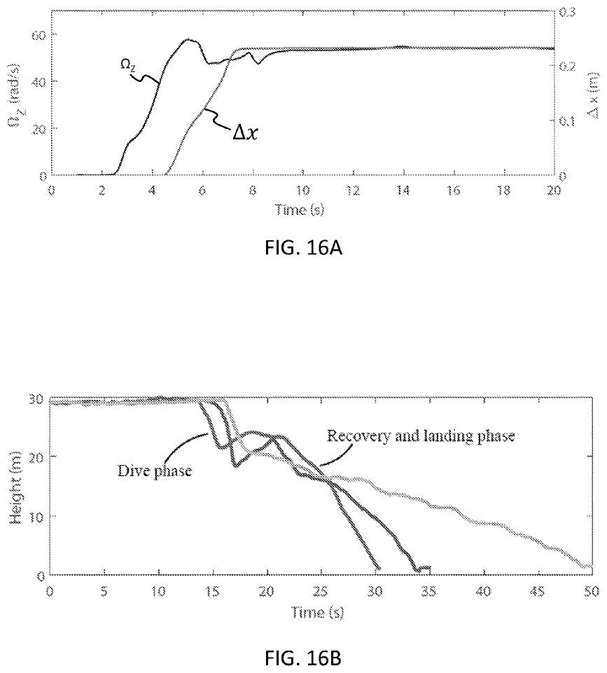

FIG. 16A shows a plot of experimental results for the angular velocity of the example FROW-P rotorcraft 400 during take-off and hovering. It can be observed that the rotational speed (or angular velocity) Ω_{Z} reaches about 58 rad/s on take-off to overcome the spring force, gravity, and friction force. The plot also depicts the change in wingspan during the take-off. It can be observed that the wingspan slowly starts to increase after reaching a rotational speed of around 43 rad/s. During hover, the rotational speed Ω_{Z} was about 54 rad/s. FIG. 7C depicts the example FROW-P rotorcraft 400 taking off from stand still, where the expansion of the wing can be noticed with the increase in the angular velocity.

The spring parameters of the example FROW-P rotorcraft's folding mechanism were carefully chosen based on experimentation. Two key points were considered for the selection of these parameters. Firstly, there should be enough spring force at the fully folded state, so that the wing does not unfold itself. This ensures easier handling of the rotorcraft for storage or while taking off. Secondly, in case the motor is switched of while flying, the rotorcraft is designed to have a sufficient centrifugal force so that the wing docs not automatically fold. This ensures that the wing does not fold and simply crash in the event of a power failure. The natural tendency of the rotorcraft to auto-rotate will help it gradually descend. A reverse thrust mechanism was implemented on the motor onboard the example FROW-P rotorcraft 400 to rapidly decrease the angular velocity below the required amount, enabling the example FROW-P rotorcraft 400 to dive.

FIG. 16B shows a plot of experimental results (barometer data) for the dive and recovery of the example FROW-P rotorcraft 400 from 30 m altitude in an outdoor experiment, where the rotorcraft was hand thrown from a 30 m altitude to imitate a launch. After passing through an initial dive phase for about 10 m, the ability to recover from a dive was demonstrated. Several experiments were performed and results for three different experiments are shown in FIG. 16B.

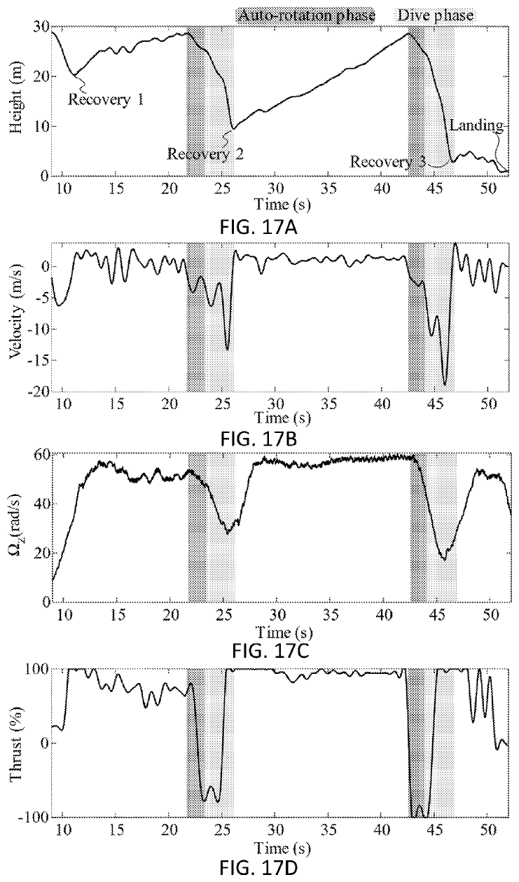

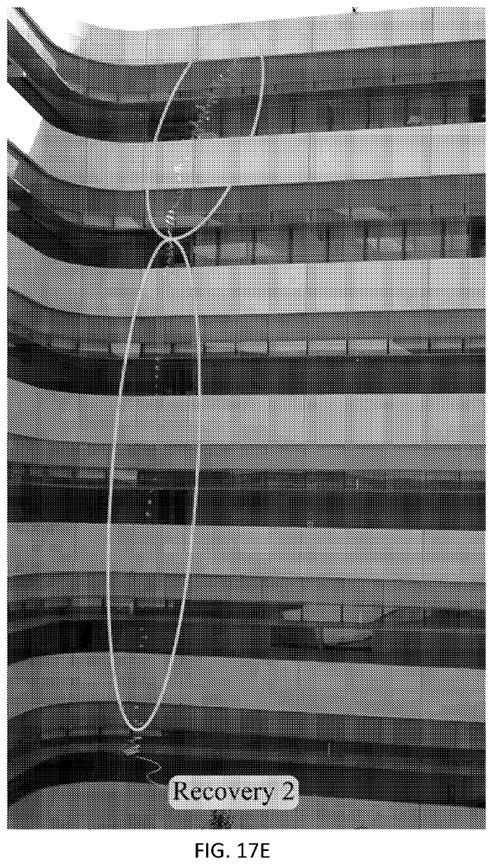

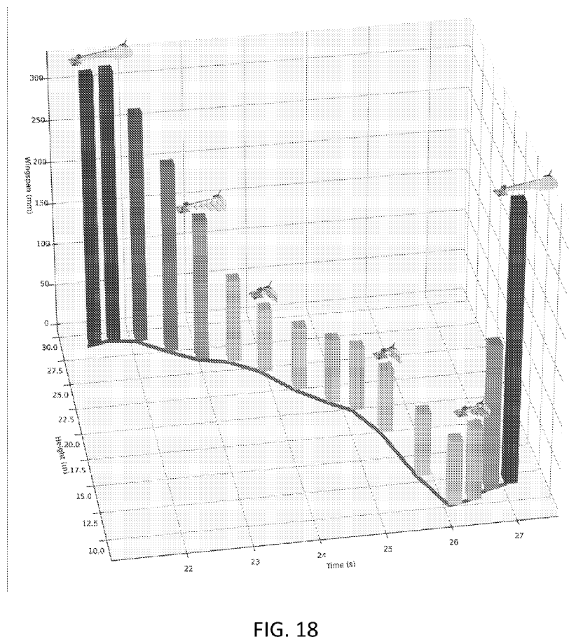

FIGS. 17A to 17D depict the experimental results obtained from the dive and recovery experiment for the example FROW-P rotorcraft 400 performed from a height of 30 m. In particular, FIG. 17A depicts a plot of the barometric height, FIG. 17B depicts a plot of the velocity calculated from the height data, FIG. 17C depicts a plot of the angular velocity and FIG. 17D depicts a plot of the PWM value of the thrust input to the trust unit. Furthermore, FIG. 17E shows overlaying frames from a video showing the outdoor experiment performed. The experiment shows firstly the recovery of the example FROW-P rotorcraft 400 after it is hand thrown from a height of 30 m. After flying back to nearly the same altitude, the reverse thrust mechanism is turned on to initiate the dive mode. Since the motors are rotating at high RPM, the reverse thrust mechanism takes a couple of seconds to turn on, during which the example FROW-P rotorcraft 400 falls while auto-rotating. The example FROW-P rotorcraft 400 was allowed to fall for about 20 m and is recovered again to repeat the experiment for an even deeper fall (25 m). The velocity for the example FROW-P prototype 400 was obtained using differentiation, as a result, a lot of noise was obtained which was filtered to obtain the velocity profile. In a similar manner, the angular velocity profile was obtained from the heading angle data recorded from the magnetometer. During the first drop, the maximum velocity of the example FROW-P prototype 400 was about-13 m/s, whereas, for the second drop, the maximum velocity was about-18 m/s. The experiment shows the ability of the example FROW-P rotorcraft 400 to fully collapse its wing while in flight using the applied mechanism and recover at various distances while falling with different velocities. FIG. 18 shows a plot of the change of altitude and wingspan of the example FROW-P rotorcraft 400 over time for the FROW-P rotorcraft dive and recovery experiment shown in FIGS. 17A and 17E.

Accordingly, the example rotorcraft 400, 500 described herein according to various example embodiments advantageously has the ability to fold its wings, actively or passively, during flight. In particular, two different configurations (FROW-A and FROW-P) have been described, featuring active or passive wing folding mechanisms depending on specific application requirements. FROW-A and FROW-P rotorcrafts can reduce their overall footprint (wingspan) by about 40% and 70%, respectively, while in flight. A cyclic controller may be implemented for controlling the translational motion, where the direction is controlled by pulsing the motors at a specific instance during each cycle of rotation. Experimental results have been presented to prove the control of the example FROW-A and FROW-P rotorcrafts 400, 500 in different modes while in flight. The example rotorcraft 400, 500 described herein according to various example embodiments can thus enhance usability/applicability for a wider range of practical applications, such as providing the ability to reduce the footprint of the rotorcraft 500 while in flight actively, or by allowing the rotorcraft 400 to dive through the air without any additional actuator. Experimental results have been presented based on experimentation performed on the example physical prototypes (example FROW-A and FROW-B prototypes) constructed through the design principles described herein according to various example embodiments. The active wing folding mechanism described herein can achieve stable flight and position control in both expanded and folded configurations. The stable flight achieved during the folded wing configuration shows the ability of the rotorcraft 400, 500 to navigate through narrow spaces.

The passively foldable rotorcraft 400 described herein according to various example embodiments is a unique monocopter configuration is capable of expanding its wing 412 under the influence of the centrifugal force generated while rotating if the centrifugal force is sufficient to overcome the spring force produced by the spiral spring 424. The spiral spring mechanism 424 operates to retract the wing 412, as soon as the centrifugal force is overpowered by the spring force being produced by the spiral spring 424. The modeling of the spring force and the centrifugal force for the rotorcraft 400 has been presented herein to show the relationship between the rotational speed and the displacement Δx of the wing 412. The model has further been verified experimentally. For example, experiments conducted demonstrated the ability of the rotorcraft 400 to fold its wing 412 and dive through the air and eventually recover from the dive through the expansion of the wing 412.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A rotorcraft with adjustable wingspan, comprising:
a housing member having disposed thereon a flight controller operable to control a flight of the rotorcraft;
a wing member coupled to the housing member at a first side thereof, wherein the wing member is configured to produce an aerodynamic force for generating a lift when the rotorcraft is rotating and the wing member is in an extended state;
a wingspan control system coupled to the housing member and configured to control a wingspan of the wing member during flight between the extended state and a folded state, wherein the wingspan control system comprises a wing support frame configured to support the wing member; and
a thrust unit configured to generate a thrust for rotating the rotorcraft, wherein the flight controller is communicatively coupled to the thrust unit for controlling the thrust unit to control the flight of the rotorcraft.

2. The rotorcraft according to claim 1, wherein the wing member comprises a plurality of wing panels arranged in series and a plurality of foldable portions, each foldable portion being located between a corresponding pair of immediately adjacent wing panels.

3. The rotorcraft according to claim 2, wherein
the wing member is laminated with a film, and
each portion of the film located between a corresponding pair of immediately adjacent wing panels forms the corresponding foldable portion located between the corresponding pair of immediately adjacent wing panels.

4. The rotorcraft according to claim 2, wherein the wing support frame is coupled to the wing member at multiple foldable portions of the plurality of foldable portions and at a last wing panel of the plurality of wing panels for supporting the wing member and facilitating transitions of the wing member between the extended state and the folded state.

5. The rotorcraft according to claim 4, wherein
the wing support frame is arranged alongside a leading edge of the wing member and is configured to function as a guide rail for the plurality of wing panels, and
the thrust unit is coupled to the wing support frame at a distal end portion thereof.

6. The rotorcraft according to claim 2, wherein the wingspan control system is configured to fold the wing member in an accordion manner.

7. The rotorcraft according to claim 2, wherein
the wingspan control system further comprises a spring device and a string having a first end coupled to the spring device and a second end coupled to the wing member for controlling the wingspan of the wing member, and
the spring device is configured to:
when in the folded state, hold the wing member in the folded state via the string with a pre-loaded spring force pulling on the wing member; and
release the wing member towards the extended state when the rotorcraft is controlled by the flight controller to rotate at a rotational speed which generates a centrifugal force which exceeds a spring force pulling on the wing member produced by the spring device via the string, thereby increasing the wingspan of the wing member and storing elastic potential energy in the spring device.

8. The rotorcraft according to claim 7, wherein the spring device is configured to retract the wing member towards the folded state when the rotorcraft is controlled by the flight controller to rotate at a rotational speed which generates a centrifugal force which is less than the spring force pulling on the wing member produced by the spring device via the string, thereby reducing the wingspan of the wing member.

9. The rotorcraft according to claim 7, wherein the wing support frame is a telescopic rod and the spring device is a spiral spring device.

10. The rotorcraft according to claim 1, wherein the rotorcraft is a monocopter.

11. The rotorcraft according to claim 2, wherein
the wingspan control system further comprises a servo motor and a string having a first end coupled to the servo motor and a second end coupled to the wing member for controlling the wingspan of the wing member, and
the servo motor is configured to:
retract, based on the servo motor receiving a wingspan control input to retract, the wing member towards the folded state by reeling in the string, thereby reducing the wingspan of the wing member; and
release, based on the servo motor receiving a wingspan control input to release, the wing member towards the extended state by releasing the string for allowing the wing member to extend towards the extended state via a centrifugal force produced when the rotorcraft is being rotated, thereby increasing the wingspan of the wing member.

12. The rotorcraft according to claim 1, wherein
said wing member is a first wing member,
said wingspan control system is a first wingspan control system,
said thrust unit is a first thrust unit, and
the rotorcraft further comprises:
a second wing member coupled to the housing member at a second side thereof, wherein the second wing member is configured to produce an aerodynamic force for generating a lift when the rotorcraft is rotating and the second wing member is in an extended state;
a second wingspan control system coupled to the housing member and configured to control a wingspan of the second wing member during flight between the extended state and a folded state, wherein the second wingspan control system comprises a second wing support frame configured to support the second wing member; and
a second thrust unit configured to generate a thrust for rotating the rotorcraft, wherein the flight controller is communicatively coupled to the second thrust unit for controlling the second thrust unit to control the flight of the rotorcraft.

13. The rotorcraft according to claim 12, wherein the second wing member comprises a plurality of wing panels arranged in series and a plurality of foldable portions, each foldable portion being located between a corresponding pair of immediately adjacent wing panels.

14. The rotorcraft according to claim 13, wherein
the second wing member is laminated with a film, and
each portion of the film located between a corresponding pair of immediately adjacent wing panels forms the corresponding foldable portion located between the corresponding pair of immediately adjacent wing panels.

15. The rotorcraft according to claim 13, wherein the second wing support frame is coupled to the second wing member at multiple foldable portions of the plurality of foldable portions and at a last wing panel of the plurality of wing panels for supporting the second wing member and facilitating transitions of the second wing member between the extended state and the folded state.

16. The rotorcraft according to claim 15, wherein
the second wing support frame is arranged alongside a leading edge of the second wing member and is configured to function as a guide rail for the plurality of wing panels, and
the second thrust unit is coupled to the second wing support frame at a distal end portion thereof.

17. The rotorcraft according to claim 13, wherein the second wingspan control system is configured to fold the second wing member in an accordion manner.

18. The rotorcraft according to claim 13, wherein
the second wingspan control system further comprises a servo motor and a string having a first end coupled to the servo motor and a second end coupled to the second wing member for controlling the wingspan of the second wing member, and
the servo motor is configured to:
retract, based on the servo motor receiving a wingspan control input to retract, the second wing member towards the folded state by reeling in the string, thereby reducing the wingspan of the second wing member; and
release, based on the servo motor receiving a wingspan control input to release, the second wing member towards the extended state by releasing the string for allowing the second wing member to extend towards the extended state via a centrifugal force produced when the rotorcraft is being rotated, thereby increasing the wingspan of the second wing member.

19. A method of forming the rotorcraft with adjustable wingspan according to claim 1.
